(19) United States
(12) Patent Application Publication
(10) Pub. No.: US 2017/0058669 A1
(43) Pub. Date: Mar. 2, 2017

(54) APPARATUS AND METHOD OF USING MEASUREMENT WHILE DRILLING DATA TO GENERATE MECHANICAL ROCK-STRENGTH PROPERTIES AND MAP MECHANICAL ROCK-STRENGTH PROPERTIES ALONG A BOREHOLE

(71) Applicant: Fracture ID, Inc., Denver, CO (US)

(72) Inventors: James D. Lakings, Evergreen, CO (US); Jesse B. Havens, Denver, CO (US)

(73) Assignee: Fracture ID, Inc., Denver, CO (US)

(21) Appl. No.: 15/263,278

(22) Filed: Sep. 12, 2016

Related U.S. Application Data
(63) Continuation-in-part of application No. 15/182,012, filed on Jun. 14, 2016.
Application No. 15/182,012 is a continuation of application No. 14/850,710, filed on Sep. 10, 2015.
(60) Provisional application No. 62/216,832, filed on Sep. 10, 2015.
(60) Provisional application No. 62/048,669, filed on Sep. 10, 2014.

(51) Int. Cl. E21B 49/00; G01N 3/40; G01V 11/00; E21B 43/26

(52) U.S. Cl. CPC E21B 49/003; E21B 43/26; G01N 3/40; G01V 11/002

(57) ABSTRACT

The present disclosure involves a obtaining force and motion data from a measurement while drilling apparatus or the like having sensors measuring forces and motions of the drill bit while drilling a well. The force and motion data is transformed into spectral pairings from which distributions, such as force displacement and power law relationship, are generated. From the distributions various rock strength properties along the well bore may be derived and used in various possible completion processes such as perforation placements and packer placements.

### RELATED APPLICATIONS

This claims priority under 35 U.S.C. §119 to co-pending U.S. Provisional Patent Application No. 62/216,832 entitled “METHOD OF USING MEASUREMENT WHILE DRILLING (MWD) DATA TO CALCULATE MECHANICAL ROCK-STRENGTH PROPERTIES,” filed on Sep. 10, 2015, which is incorporated by reference in its entirety herein for all purposes. This application is also a continuation-in-part of co-pending U.S. Nonprovisional patent application Ser. No. 14/850,710 entitled “APPARATUS AND METHOD USING MEASUREMENTS TAKEN WHILE DRILLING TO MAP MECHANICAL BOUNDARIES AND MECHANICAL ROCK PROPERTIES ALONG A BOREHOLE,” filed Sep. 10, 2015, which claims priority to U.S. Provisional Patent Application No. 62/048,669 entitled “APPARATUS AND METHOD USING MEASUREMENTS TAKEN WHILE DRILLING TO MAP MECHANICAL BOUNDARIES AND MECHANICAL ROCK PROPERTIES ALONG A BOREHOLE,” filed on Sep. 10, 2014, both of which are hereby incorporated by reference in their entirety for all purposes. This application is also a continuation-in-part of and claims priority to application Ser. No. 15/182,012 “APPARATUS AND METHOD USING MEASUREMENTS TAKEN WHILE DRILLING TO MAP MECHANICAL BOUNDARIES AND MECHANICAL ROCK PROPERTIES ALONG A BOREHOLE,” filed Jun. 14, 2016, which is hereby incorporated by reference in their entirety for all purposes.

### TECHNICAL FIELD

The present disclosure involves measurement while drilling techniques that provide mechanical rock properties, and from which wellbore rock properties and other may be identified and used to improve drilling and completion practices, including identification of hydraulic fracture entry points and hydraulic fracture stages, among other things.

### BACKGROUND

The production of hydrocarbons (oil or gas) can be generally distilled into two primary steps—drilling a borehole to intersect hydrocarbon bearing formations or oil and gas reservoirs in the subsurface, and then completing the well in order to flow the hydrocarbons back to the surface. The ability of a well to flow hydrocarbons that are commercially significant requires that the borehole be connected to oil and gas bearing formations with sufficient permeability to support the flow rates that are needed to account for the costs of developing the field. In many instances, however, commercially viable flow rates cannot be obtained without the use of various advancements including horizontal drilling and hydraulic stimulation due to the type of formation or reservoir being developed.

More specifically, unconventional resource plays are areas where significant volumes of hydrocarbons are held in reservoirs with low primary permeability (nanodarcy to microdarcy) and low primary porosity (2-15%) such as shales, chalks, marls, and cemented sandstones that generally do not have sufficient primary permeability to yield commercial quantities of hydrocarbons. Compared to “conventional” reservoirs, unconventional reservoirs have a much lower hydrocarbon density per unit volume of rock and much lower unstimulated hydrocarbon flow rates, making commercial development impossible without hydraulic stimulation of the reservoir rock fabric. Fortunately, unconventional reservoirs are often regionally extensive covering thousands of square miles and containing billions of barrel of oil equivalent (BOE) of potentially recoverable hydrocarbons.

The economically viable production from unconventional resources has only been made possible by the improvement and combination of horizontal drilling, wellbore isolation, and hydraulic fracture stimulation treatment technologies, among other techniques. Generally speaking, horizontal drilling involves first vertically drilling down close to the top of the unconventional reservoir and then using directional drilling tools to change the orientation of the wellbore from vertical to horizontal in order to contact greater areas of the reservoir per well. The term “horizontal” drilling as used herein is meant to refer to any form of directional (non-vertical) drilling. Horizontal drilling, although having been performed for many decades prior to intensive unconventional resource development in the early 2000's, has been evolved to provide cost effective provisioning of the long horizontal borehole sections (5,000′ to 10,000+′) required to contact commercially viable volumes of hydrocarbon bearing reservoir rock. Hydraulic fracture stimulation involves pumping high volumes of pressurized fluid into the borehole and through targeted perforations in the wellbore to create large networks of cracks (fractures) in the formation that create enhanced reservoir permeability and so stimulate greater quantities of oil and gas production. Proppant is usually pumped along with the fluid to fill the fractures so permeability is maintained after the pumping is stopped and the fractures close due to reservoir stresses. Proppant can range from simple quarried sand to engineered man-made materials.

Isolation generally involves the use of some form to technology to focus where fracturing occurs at specific locations along the well bore rather than stimulating the entire length of an open wellbore. In the development of unconventional resources, it is desirable to drill horizontal wells perpendicular to the direction of maximum horizontal compressive stress, because hydraulically induced fractures will grow primarily in the direction of maximum horizontal stress. When the wellbore is oriented perpendicular to the maximum horizontal compressive stress, this geometry allows for the shortest, and hence least expensive, well bore length for the volume of reservoir stimulated.

Rapidly evolving wellbore isolations techniques, such as swellable packers, sliding sleeves, and perforation cluster diversion have all assisted in reducing the cost of isolating sections of the wellbore for more targeted and more concentrated hydraulic stimulation. Hydraulic fracture stimulation has been utilized on low permeability wells for decades as well. But the use of low viscosity, simple fluids pumped in very high volumes and rates, and with large volumes of associated proppant, has been the most important aspect of contacting the greatest amount of low permeability, low hydrocarbon density reservoir rock.

Various suites of drill string or wireline conveyed well logs such as dipole sonic or natural fracture image logs can identify and quantify this variability on a scale that is useful to completions design, but existing tools are currently too expensive to run on anything but a very small fraction of unconventional wells drilled. Conventional techniques, such as dipole sonic and natural fracture image logs, are based on inferred information and not involved directly measuring the interaction of the drill bit with the formation. Instead, dipole sonic involves the transmission of acoustic signals (waves) from a controlled active acoustic source, through the rock formation in the areas of the well bore to a receiver typically several feet from the source, to measure the velocity of the waves through the formation. Natural fracture image logs involve measuring the resistivity of the formation along the walls of the wellbore. Natural fracture logs are of limited use in wells using oil based mud, which has an inherently high resistivity and masks some fractures. These techniques are often cost prohibitive and limited in effectiveness. As a result, almost all wells are completed using geometrically equal spacing of zones isolated (referred to as stages) and stimulated. Thus, for example, hydraulic fracturing is inadvertently performed routinely on individual stages with significantly varying rock properties along the isolated section, resulting in the failure to initiate induced fractures in less conducive rock and so potentially bypassing substantial volumes of hydrocarbon bearing rock. In such instances, post stimulation testing of individual zones or stages shows that a significant percentage of the hydraulically stimulated zones are not contributing to hydrocarbon production from the well. Variations in the density, size and orientation of natural fractures can have a major influence on overall well initial production, long term decline rates, and stage to stage contributions. Formation hydrocarbons are transported from the rock matrix to the producing wellbore through some combination of induced hydraulic fractures and natural occurring in-situ fractures.

Currently, less than 1% of all wells drilled and completed have suitable data to adequately quantify reservoir heterogeneity on a scale that can be used for targeting individual stimulation intervals.

It is with these observations in mind, among others, that aspects of the present disclosure have been conceived and developed.

### SUMMARY

Aspects of the present disclosure involve a method of characterizing rock properties comprising accessing, by a processor, time domain force and motion data collected from sensors associated with a drill bit interacting with a rock formation while drilling a wellbore. In one example, the method may involve receiving acoustical signals obtained from the sensors positioned on a component of a bottom hole assembly where the sensors (e.g., accelerometers or strain gauges) are in operable communication with at least one data memory to store the acoustical signals. The acoustical signals, which may also be considered vibrations, are generated from a drill bit interacting with a rock formation while drilling a wellbore. The method may further involve accessing, by the processor, spectral pairings generated from transformations of the time domain force and motion data. Additionally, the method may involve generating, by the processor, a rock strength property from a distribution of the spectral pairings.

Another aspect of the present disclosure involves a method of characterizing rock strength properties comprising: accessing, using a processor, time domain force and motion data collected from a sensor associated with a drill bit interacting with a rock formation while drilling a wellbore. The force and motion time domain data is captured over a rotation (partial, full or multiple) of the drill bit where the formation experiences elastic and plastic deformation. The method further involves accessing, using the processor, spectral pairings of force amplitude and motion amplitude, the spectral pairings from transforming the time domain drill bit forces and motions data in frequency domain drill bit forces and motions data. The forces may be in the form of amplitude of force (or ensemble of amplitudes) and an amplitude of motion (or ensemble of amplitudes) paired according to frequency. The spectral pairings may be accessed or may be generated from Fourier transformations or otherwise. The method may further involve generating, using the processor, an elastic plastic transition of the rock formation where the elastic plastic transition is from a distribution of the spectral pairings of force amplitude and motion amplitude. The method may further involve identifying or otherwise generating, using the processor, a force at a point of the elastic plastic transition and identifying or otherwise generating, using the processor, a rock strength property from the force at the point of the elastic plastic transition.

Yet another aspect involves a method of characterizing rock strength properties comprising: accessing, using a processor, time domain force and motion data collected from sensors associated with a drill bit interacting with a rock formation while drilling a wellbore. The method may further involve accessing, using the processor, spectral pairings of a ratio of motion/force amplitude and a motion amplitude, the spectral pairings from transforming the time domain forces and motions data into frequency domain drill bit forces and motions data and identifying or otherwise generating, using the processor, a critical strain energy release rate from a distribution of the spectral pairings, the critical strain energy based on a slope of the distribution at a point of elastic plastic transition and a force at the elastic plastic transition.

Another aspect involves an apparatus comprising a processing unit in communication with at least one tangible machine readable media including computer executable instructions to perform the operations of the various methods, or portions thereof, discussed herein. The processing unit may be part of a measurement while drilling apparatus and/or a computing device configured to process data collected from the measurement while drilling apparatus.

These and other aspects are disclosed in further detail in the description set out below.

### BRIEF DESCRIPTION OF THE FIGURES

FIGS. 1A-1B Illustrate reservoir-to-well connectivity where brittle rocks are generally associated with larger fracture creation and better proppant support that is more permeable than ductile rock that produces smaller, less productive fractures which are prone to rapid compaction and closure and are less permeable.

FIG. 2A-2B is a diagram of a drill bit assembly including sensors for measuring bit accelerations and forces on the bit, and which includes at least one processing unit and tangible storage media in which to store acceleration and/or force data, and which may also store processed acceleration and/or force data of the drill bits interaction with a formation while drilling.

FIGS. 3A-3C illustrate the cutting action of a drill bit, stick slip fracturing of a rock formation, torque-on-bit and weigh on bit forces, and related torque and displacement curves.

FIG. 4 is a method of obtaining mechanical rock properties of a formation proximate a well bore from measurements of bit behavior taken while drilling.

FIG. 5 is a stress displacement diagram plotting a spectral pairings of ensemble averages of annular pressure and axial displacement based on time domain measurements from sensors obtaining and recording drill bit motions and forces while drilling.

FIG. 6 is a force displacement diagram plotting an spectral pairings of ensemble averages of torque-on-bit and shear (e.g., angular) displacement based on time domain measurements from sensors obtaining and recording drill bit motions and forces while drilling.

FIG. 7 are representative power law curves from ensemble force displacement diagrams with the lower curve representing a power law curve for deformation where the mode of deformation can be considered ductile such that the rock becomes harder with increasing strain with the upper curve being a related strain hardening coefficient curve where the higher the strain hardening coefficient, the strong the rock becomes for an equivalent strain.

FIG. 8 is a Coulomb strength diagram generated from motion and force data collected while drilling.

FIG. 9A is a force displacement diagram based on spectral pairings generated from torque-on-bit and angular displacement data, with an initial yield strength computed at the frequency associated with a point of maximum curvature of the diagram.

FIG. 9B is a compliance length diagram based on spectral pairings of angular displacement/torque-on-bit and angular displacement for measurements coinciding with those of FIG. 9A, with the critical strain energy release rate based on the initial yield strength computed from the distribution of FIG. 9A.

FIG. 10 is a diagram of a distribution of ensemble averages of spectral pairings of torque-on-bit and annular pressure, where a point of transition between elastic and plastic deformation involves forming the spectral pairs between the torque-on-bit and the annular pressure, fitting a line to the low-frequency pairs and fitting a line to the high frequency pairs and obtaining the intersection between the two lines.

FIG. 11 is a diagram illustrating Vsand and Vclay with an overlay of initial yield strength where there is a high IYS the value of Vsand−Vclay increases and conversely a low value of IYS corresponds to low values of Vsand−Vclay.

FIG. 12 is a special purpose computer programmed with instructions to execute methods described herein.

### DETAILED DESCRIPTION

The present disclosure involves a novel and non-obvious way of using drilling motions representative of displacement, such as may be captured using an accelerometer measuring angular and/or axial drill bit motions, and drilling forces, such as may be captured using strain gauges measuring forces associated with the angular and/or axial drill bit motions, where the motions and forces are generated by the deformation of a rock formation related to a drill bit cutting a wellbore during a drilling operation. The drilling motion and force measurements are transformed into the frequency domain. From the frequency domain, the amplitudes of two spectra, where one spectra represents a motion and the other spectra represents a force, are paired together at each frequency. Spectral pairs may be generated and used to generate a distribution, such as a force-displacement diagram, which may be correlated to positions along the wellbore. From the force displacement diagram and the spectral pairs more generally, various rock properties may be derived and used in various operations. For example, the Initial Yield Strength (IYS) may be derived and correlated to positions along the wellbore. The IYS may be used to identify the nature and occurrence of fractures, fracture swarms and other mechanical discontinuities (boundaries) such as bedding planes and/or faults that offset or otherwise separate rock formations with different mechanical rock properties. This information may further be used in completions, such as where to target stimulation, and in numerous other ways.

The techniques and measurements from this disclosure are made using downhole tools that are simple and rugged, allowing for a magnitude in order reduction in logging cost to characterize near-wellbore rock mechanical properties and intersected existing fracture locations. The low cost to log a well, which may be less than 0.5% of the total well cost, allows for widespread use of the technique. Detailed knowledge of rock property characteristics and variability along a wellbore allows for grouping like-for-like rock types in variable length stages, avoiding losing reserves due to a lack of fracture initiation relative to mixed rock strength stages, among other advantages. Also, knowledge of existing fractures will improve well economics overall as fractures can be targeted for stimulation to improve initial production if appropriate, or avoided for example when setting swell packer locations. Outside of drilling, the technique may also be useful in characterizing properties of rotating members and related structures, such as rotating shafts and bearings, among other things.

Further elaboration of the method describes the generation of mechanical rock properties, and in particular the IYS, rock cohesion, angle of internal friction, uniaxial compressive strength, uniaxial tensile strength, Coulomb strength, confining pressure, compliance length diagrams and other useful information concerning a rock formation. The information, may be used, in general to describe the deformation of a rock formation in response to the forces acting on the rock formation, and in particular, to identify preexisting fractures and predict the deformation of a hydrocarbon bearing formation in response to the forces acting on the formation where the forces are fluid pressures generated during the emplacement of hydraulic fractures in connection with a hydraulic fracture stimulation treatment along a horizontal well, among other things.

The processing of drilling induced motions and forces when recorded using sensors deployed in a borehole in connection with a bottom hole assembly (BHA), such as may be provided from a measurement while drilling (MWD) assembly and a bit sub, and according to the methods disclosed here, can provide rock properties including the nature and occurrence of mechanical discontinuities, such as pre-existing fractures, which can be used to target sections of the well where the rock properties are conducive to economical hydraulic stimulation and to avoid sections that are viewed as sub-commercial, where the rock properties are not conducive to economical hydraulic stimulation.

In another embodiment of the method, the rock strength (e.g., IYS, fracture toughness, secant modulus, tangent modulus, uniaxial compressive and tensile strengths, and others) and variations in the rock strength that are obtained while conducting drilling operations can be used for assisting, in real-time, the steering of the bottom hole assembly in order to maintain the tracking of the drill bit through geological formations as are targeted according to the desired mechanical rock properties, especially where the mechanical rock properties are relevant to the production of commercially significant hydrocarbons using hydraulic fracturing stimulation techniques.

The techniques described in this disclosure will provide new information for selecting hydrocarbon bearing zones by differentiating between brittle rocks generally associated with larger fracture creation and better proppant support that is more permeable than ductile rock that produces smaller, less productive fractures which are prone to rapid compaction and closure and are less permeable. Natural fracture identification also refines the process of hydraulic stimulation optimization by providing direct measurement of zones that offer higher permeability and higher hydrocarbon productivity.

Aspects of the present disclosure involve methodologies that use broad band measurements (e.g., continuous, high resolution) of drilling motions, which may also be referred to as vibrations, and drilling dynamics data, such as forces, taken proximate the drill while conducting drilling operations to log the mechanical properties of a rock formation. Drilling vibrations generated by the deformation and failure of a rock formation are generally related to the mechanical properties of the rock being drilled. It is generally understood that the depth of cut or the tooth penetration into the rock is inversely related to the strength of the rock. Higher amplitude drilling vibrations occur in rocks that undergo a greater depth of cut and deeper tooth penetration in response to the forces acting on the formation in connection with the drill bit and drilling fluid system, whereas lower amplitude drilling vibrations occur in rocks that undergo relatively lower depth of cut and lesser tooth penetration. Increased depth of cut indicates the bit is moving into an area of lesser relative mechanical rock strength, and decreased relative drilling vibrations indicate the bit is moving into an area of greater relative rock strength all other things being equal.

Generally speaking, rock formations that take a relatively long time to drill through or where the rate of penetration is slow are generally referred to strong or hard formations and have a lesser depth of cut in relation to rock formations that are relatively weaker and less rigid. These basic principles have enabled the application and use of techniques that take measurements of the hardness of a rock formation by forcing a tool into a rock to make an indentation where the depth of the indentation relative to the force applied is used to obtain a hardness characteristic that is essentially a mechanical property of a rock formation.

The presence of mechanical discontinuities, such as pre-existing fractures, and geological boundaries, such as faults, in a rock formation generally act to weaken the rock formation. Fractured rock formations, are generally weaker and less rigid than intact, un-fractured or stiff or otherwise competent rock formations. As the drill bit encounters fractures, transitioning, for example, from an unfractured or less fractured area to a fractured or more fractured area, in a rock formation the tooth penetration or depth of cut and subsequently the drilling vibrations will increase, because the rock formation is less rigid because it has been weakened by the presence of fractures. Stated differently, as the drill moves into and through existing fractures, the measured mechanical rock strength will decrease relative to the same rock formation without a fracture or with lesser fractures, for example.

Signal processing techniques are used to process the force displacement curves to identify locations along the wellbore where the rock strength or changes in the rock strength indicate that the drill bit has encountered a mechanical discontinuity (e.g., preexisting fractures) or geological boundary. If the changes in the drilling vibration and forces as expressed through the force displacements diagrams and rock information derived therefrom are rapid and discrete in both space and time, and then return back to a long-term trend or the levels that were recorded prior to the change in the drilling vibrations and forces as expressed through the amplitudes and frequencies of the forces and displacements, then it would indicate that that the drill bit has encountered and crossed a discrete mechanical discontinuity because mechanical rock properties that are discrete in both space and time are uniquely separated from the mechanical properties of a rock formation such as would be in the case of a drill bit penetrating a fracture face. If the changes in drilling information are rapid and discrete and continue over a short interval, then that would indicate multiple fractures or a swarm of fractures has been encountered.

If the signal processing techniques indicate that the changes in the amplitudes and frequencies of the forces and displacements, as evidenced through the processing and analysis of the force displacement curves, are rapid, but then do not revert back to the level prior to the change and instead carry on at a new, significantly different level, then that indicates a mechanical boundary where the mechanical boundary that separates or offsets two different rock formations such as a bedding plane and or fault has been encountered and crossed as evidence by the change in rock strength across the boundary. Whether or not the boundary is related to a fault or a bedding plane depends on the inclination of the bit with respect to the orientation of the stratigraphy of the rock formation being drilled. Other information may also be used to determine whether or not the mechanical boundary was a bedding-plane fault or bedding plane that acted as a zone of weakness that had experienced measurable displacement in the past.

The description provides a method to evidence the presence of fractures, fracture swarms and other mechanical discontinuities such as faults and bedding planes that offset or otherwise separate rock formations with different rock properties. The approach uses geophysical signal processing techniques that are sensitive to changes in the drilling motions and forces where the changes are relative to some baseline, such as a normalized preceding set of drilling data, and whether or not the changes are discrete and then return back to the level prior to the change or are maintained at a new level that is different than the level observed prior to the change.

The following method disclosed below further elaborates on the outlined principles to provide a general, independent method to specify the mechanical properties of a rock formation by processing the drilling motions in relation to the forces acting on the formation in connection with a drill bit and, in some instances, a drilling fluid system, which includes the mud motor and the drilling fluid, including mud, that turns the motor and the pressure of the mud on the formation. Through the techniques described herein, the drilling vibration characteristics, which are supplemented with drilling dynamics data including forces on the bit, such as torque-on-bit and weight-on-bit, are translated into mechanical properties of a rock formation.

The present disclosure involves an innovative, new system, apparatus and method to specify, in general, the mechanical properties of a rock formation from an analysis of drilling vibrations generated by the cutting action of the bit and the deformation of the formation in response to the forces acting on the rock formation in connection with the drill bit and drilling fluid system while conducting drilling operations. Deformation may include elastic deformation, plastic deformation, and failure of the rock, which may be considered fracturing. Stated differently, aspects of the present disclosure involve obtaining information associated with the drilling of a borehole, while drilling, to identify mechanical rock properties of the formation being drilled. Such mechanical rock properties may be used, in some examples, to identify the presence of natural fractures or rock properties more or less susceptible to stimulation techniques. For example, knowing mechanical rock properties along a borehole or the presence of natural fractures along a borehole may be used to optimize hydraulic fracturing operations by focusing such fracturing on areas where it will be most effective, among other advantages. Mechanical rock properties may include strength measurements such as IYS and others discussed herein.

The mechanics of drilling a well provide a natural, in-situ, means to measure the deformation of a rock formation and gather data suitable for determining mechanical rock properties, because the penetration of the drill bit is in and of itself accommodated by repeatedly fracturing the rock formation by using the bit to generate forces on the rock formation that are sufficient to overcome the failure strength of the rock, measurements of such forces in relations to motions that accompany the forces, in relation to the methods described here may be used in predictable ways to determine the presence of natural (in situ) fractures, fracture swarms (cluster of fractures), bedding planes, fault boundaries, and other information. In some instances, variations in mechanical rock properties are used to identify fractures, bedding planes and the like.

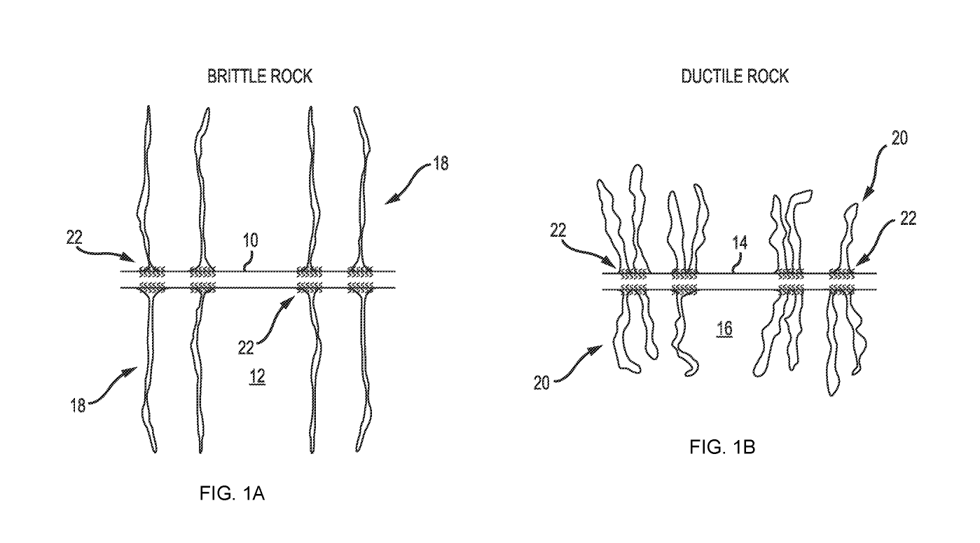

As will be understood from the present disclosure, mechanical strength and deformation of the reservoir rock influences fracture creation, propagation and ability to maintain fracture permeability. FIGS. 1A-1B are simplified diagrams illustrating the difference between fractures induced in a relatively brittle rock formation, and which may be include naturally occurring fractures, versus fractures induced in a relatively ductile rock formation, which may include fewer or no natural fractures, respectively. As illustrated in FIG. 1A, a horizontal section 10 of a borehole has been drilled through relatively brittle rock 12 and hydraulically fractured. In contrast, FIG. 1B illustrates a horizontal section 14 of a borehole drilled through relatively ductile rock 16 and hydraulically fractured. The fractures 18 created in the relatively brittle rock tend to penetrate deeper into the reservoir than the fractures 20 in ductile rock. Moreover, reservoir rock trending to the brittle end of the normal range tends to have higher initial production rates and lower decline rates. The techniques described in this disclosure will provide new information for selecting hydrocarbon bearing zones by differentiating between brittle rocks generally associated with larger fracture creation and better proppant support that is more permeable than ductile rock that produces smaller, less productive fractures which are prone to rapid compaction and closure and are less permeable. Similarly, techniques discussed herein may also identify areas where natural fractures may exist provide similar advantages as brittle rock. Generally speaking, as will be understood from the disclosure, various mechanical rock properties discussed herein will provide mechanisms whereby rock formations may be characterized, along the well bore, as to the relative brittleness or ductileness, or the relative susceptibility to stimulation techniques along the formation, which may include the identification of existing fractures or at least rock properties indicative of existing fractures

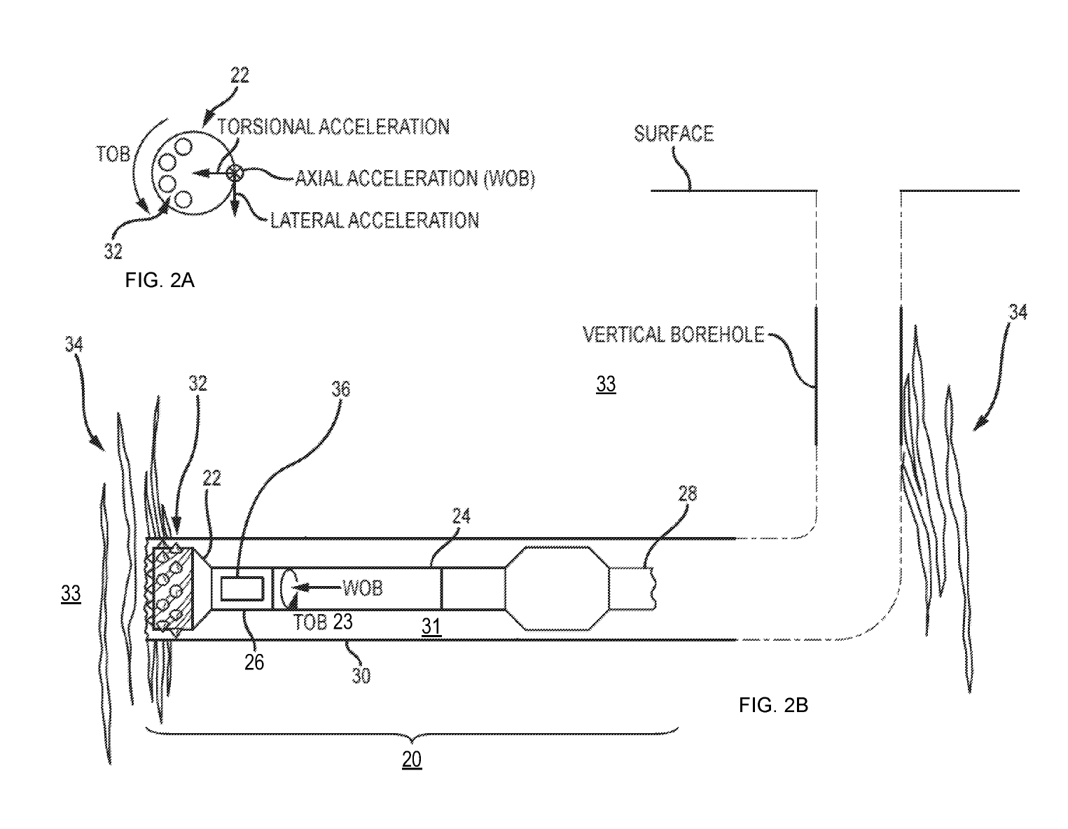

FIG. 2B is a diagram of a BHA portion 20 of a drill string where the bottom hole assembly includes a drill bit 22, a mud motor 24, a bit sub 26 including various measurement components positioned between the drill bit and the mud motor, and sections of pipe 28 within a horizontal section 30 of a borehole 31, also referred to herein as a wellbore. The section 30 may include brittle rock 12 (FIG. 1A) and ductile rock 14 (FIG. 1B) and combinations thereof. The vibration data used in the described methodologies may be recorded as close to the source (drill bit) as practical to avoid attenuation through the BHA. Forces may also be measured from components in the bit sub. One possible location for recording is directly behind the drill bit 23 and ahead of the mud motor 24 using the bit sub 26, although multiple bit subs may be used along the drill string for geophysical processing of the desired signal. Drilling a wellbore involves using a force of the weight of the drill string, known as weight-on-bit (WOB), to push the drill bit into a formation 33. The rotating force on the drill bit, known as torque-on-bit (TOB), can be generated from the surface or from a mud motor close to the drill bit. When using a mud motor, drilling mud is pumped down the drill string until it encounters the power drive section of the mud motor where a portion of the mud pressure and flow is converted into a rotational force, which is mechanically coupled to the bit to thereby place rotational torque on the bit 23 to turn the bit. The rotational force on the bit can also be augmented by or come exclusively from mechanisms at the surface on the drilling rig. The WOB and the TOB may be measured through strain gauges associated with some portion of an MWD apparatus, such as the bit sub, or more generally the BHA 20.

The objective of the drilling process is to break the rock down into fragments that are small enough that they can be lifted and evacuated from the wellbore with drilling fluids in order to continue to accommodate the forward motion of the bit. It should be noted that the action of the drill bit on a rock formation causes the fracturing of the rock formation along the borehole to drill the hole, and in the formation immediately adjacent the borehole. Moreover, the drill may encounter existing fractures 34 while drilling. Hydraulic fracturing, in contrast, is a process that occurs during the completion phase by injecting fluid into the borehole, typically with perforation clusters 22 (see FIGS. 1A and 1B) in the casing, to initiate fractures 18/20 into the formation surrounding the bore hole. As discussed herein, the casing may be perforated to facilitate fracturing based on rock strength characteristics generated from the compute and drilling measurement systems and methods discussed herein.

In the illustrated diagram, the bit sub 26 is shown between the bit 22 and the mud motor 24. The bit sub is a cylindrical component that is operably coupled between the mud motor 24 and the drill bit 22 in a way that allows the mud motor to turn the bit. The bit sub provides a housing, typically in a cylindrical shape, or mechanism to support various possible measurement components 36 including strain gauges, one or more accelerometers, pressure sensors, which may measure the pressure of the mud flow, temperature sensors which may measure the circulating temperature of the mud or other temperatures and which may be used to provide correction or offset of measurements or calculations that vary with temperature, gyroscopes which may be used to measure inclination and/or directional changes of the bit and string, and/or other components to measure or derive the information discussed herein.

In one example, as shown in FIGS. 2B and 2A, the strain gauges are mounted on the bit sub to determine the TOB and the WOB (the force turning the bit and the force pushing the bit into the rock formation). Various possible ways of mounting the strain gauges, or combinations of strain gauges, are possible. Additionally, as shown in FIG. 2A, which is a representative front view of the bit 22, accelerometers are placed to measure axial, rotary, and/or lateral acceleration of the bit. Note, the bit axis is in the center of the circle, whereas axial acceleration may be measured somewhat offset from the axis depending on the placement of the accelerometer. Acceleration measurement may be accomplished by using one or more multi-axis accelerometers. In the case of using accelerometers to measure the drilling induced motions, it may be useful to use multiple accelerometers where some of the axes of the accelerometers are oriented at right angles or oriented in opposing fashions. This is because a single accelerometer mounted tangentially to the drill collar contains both angular and linear accelerations. By summing measurements of the opposing the accelerometers together it is possible to cancel the lateral motion and obtain an angular acceleration. The angular acceleration is then transformed into the frequency domain where it can then be integrated to obtain an angular velocity and then integrated again to obtain an angular displacement.

The bit sub, or other such component, may also include a processor and memory to store computer executable instructions to implement various possible methodologies as well as a power source which may be one or more batteries. Data storage, such as the memory or other data storage mediums, is also provided to store the collected data. The bit sub may also include processors and methods to preprocess the data. For example as elaborated further below, the processor or an additional purpose specific digital signal processor, may transform time domain motion and force data in the frequency domain for storage on the bit sub, which may provide for larger data storage capacity particularly if data is gathered at frequencies at or exceeding 1 KHz. The measurement components, alone or in various possible combinations, may be provided in other locations of the drill string in the general proximity of the drill bit.

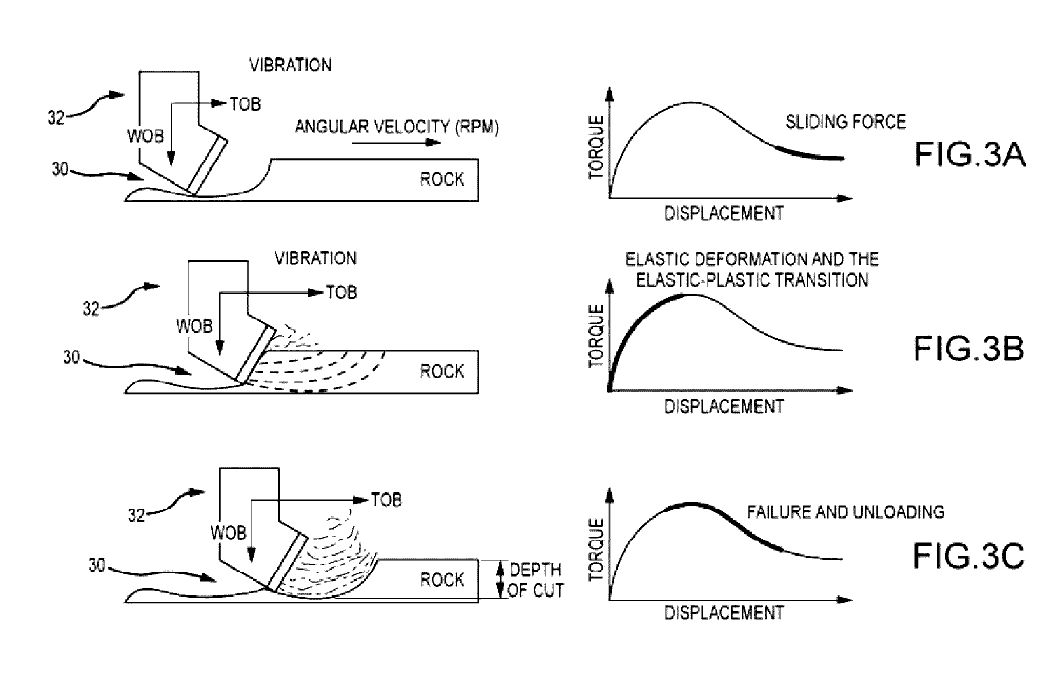

FIGS. 3A-3C are a sequence of diagrams illustrating a close up view of a cutter 32 portion of a drill bit 22 in a borehole, slipping, sticking on a portion of rock, and then slipping loose when the forces on the bit are sufficient to overcome the rock causing the rock to fracture and the bit to rotate—collectively referred to as stick slip behavior. The rock deformation mode for a PDC bit is shearing as opposed to a roller cone bit which is punching. Models that describe drilling behavior are in a large part informed on the mechanics of drilling with a roller cone bit and while these models have been extended for the application and use of PDC bits, they suffer uniquely from their inherent inability to reconcile the fundamentally different nature of rock deformation. As will be appreciated from this disclosure, the innovative, new techniques disclosed here seek to advance the application and use of PDC bits, as well as other bits, to characterize mechanical rock properties and in particular for the identification of the nature and occurrences of fractures. The figures describe the depth of cut in relationship to the area and displacement of the fractures created in response to the forces acting on the bit. The cutting action of a particular type of bit should not be construed to limit the method in the use of other types of drill bits that generate acoustic emissions from rock failure in response to the forces acting on the geometry and configuration of the bit.

More specifically, as the bit turns, the interaction of the bit with the rock formation at any instant in time, produces a complex distribution of forces acting on the formation in connection with the bit and drilling fluid system (e.g., the mud motor) where the orientation and magnitudes of the forces acting on the rock formation are related to the configuration and geometry of the cutters on the bit. Generally speaking, drilling is not a smooth and consistent process. Instead, depending on many things including the axial force on the bit, rotational torque on the bit, rock properties, and presence or absence of existing fractures, the bit cuts, gouges, spins, snags, and otherwise drills the borehole in a very complicated and varying fashion, and motions (or vibrations) of the bit are simultaneously occurring. In some instances, the complex distribution of forces acting on the formation is insufficient to initially overcome the strength of the rock formation in relation to the cutting action of the bit and the bit will stop rotating or stick.

As illustrated in FIGS. 3A and 3B, as the cutter begins to stick, the torque applied to the bit increases from a relatively steady value. As the forces, such as the illustrated torque-on-bit, applied to the bit change either through manual or automated interaction with the surface drilling apparatus or through the non-linear feedback of elastic energy stored within the drilling string or some combination of both, a new WOB and TOB are delivered to the bit. These forces on one or more particular cutters will continue to load the rock elastically until such point (i) the rock begins to deform plastically and the deformation is concentrated along fracture planes and (ii) when those forces provides a sufficient distribution of forces to overcome the failure strength of the rock formation, the bit will turn and rock, often snapping loose, and drilling will continue. As shown in FIG. 3C, when the forces overcome the rock, the torque will dramatically drop to the relatively steady value, until the bit sticks again. Such a stick slip action may occur at varying frequencies and displacements and may happen one or more times per revolution of the bit per cutter on the bit, thereby resulting in many such cutting behaviors each revolution of the bit.

Regardless of whether and the extent of stick slip behavior is experienced, deformation and failure of the rock cause the bit to vibrate. During rock deformation and in particular when the bit overcomes the rock strength at failure, stored elastic strain energy is released in the form of acoustic emissions. In some instances, the bit is fracturing rock and may intersect fractures and existing mechanical discontinuities. In some instances, the bit may reactivate existing fractures, which may itself generate a distinct acoustical signal in the form of an induced bit vibration. During all of these actions, the force data and vibration (motion) data are captured and stored.

As introduced above, a drill bit 22 typically includes many cutters 32 arranged with a geometry and configuration designed to generate sufficient forces to overcome the failure strength of the rock formation 33 based on the nature of the rock formation expected to be encountered when drilling a well. During a single rotation of the bit, at least one, but typically many of the cutters will overcome the failure strength of the rock formation and produce a plethora of acoustical emissions related to the scraping, cutting, fracturing, and other interactions between the bit and the rock formation. The tool may include various possible mechanisms, including a reed switch or gyroscopes, which measure revolutions per minute and provide information of each rotation of the bit. There are as many as 30 cutter heads, so each rotation may cause hundreds of acoustic pulses.

Because of the stochastic nature of acoustic emissions or in relation to the nearly simultaneous initiation and propagation of multiple fractures at the cutting face, the implementation of the method discussed herein may use statistical methods and signal analysis tools. In one possible methodology, the Fourier transform is understood to separate the modes of deformation, where relatively higher frequency measurements have low displacements and generally describe the forces acting on the rock formation in connection with a drill bit during elastic deformation, while relatively lower frequencies with larger displacements generally represent the forces acting on the bit in relation to plastic deformation.

The implementation of the technique as described uses signal processing techniques, such as Fourier transforms, bandpass filtering or other filtering, or combinations thereof, to calculate the motion of the bit and the forces on the bit. The motions of the bit are captured from the amplitudes and frequencies of the acoustical signals recorded by the MWD apparatus (e.g. bit sub 26) that are generated in response to the cutting action of the bit (e.g., the drilling vibrations propagate up the drill string as acoustic waves sometimes referred to as collar waves or tool mode, where they are recorded as acoustical signals by the MWD apparatus). Forces on the bit are also measured using strain gauges, in one possible implementation. The amplitudes and frequencies of the motions of the bit and the forces on the bit are used to generate a distribution, including a force displacement diagram, which facilitates the computation of mechanical rock properties. Mechanical rock properties, such as IYS, may be analyzed relative to a baseline (such as an average IYS over some wellbore distance) to identify locations where the mechanical properties of a rock formation change as the bit encounters a mechanical discontinuity or other geological discontinuity all other things being equal. In some instances, rock properties may be used to identify such locations through computations based on assumptions of the rock formation, and comparisons thereof, or otherwise.

The acoustical emissions associated with the deformation and failure of the rock formation while drilling are generally too minute and/or too attenuated by the intervening rock to be detectable at the surface (which may be hundreds or thousands of feet above the borehole). Because of the amount of energy released is generally expected to be slight and of relatively high frequency, the radiated waves are best viewed when transmitted from the cutting face through the bit and bottom hole assembly where they propagate along the drill string through acoustically conductive steel as a direct tool arrival and contribute to the vibration of the drill string. The drilling vibrations and forces can be recorded on instrumentation that is sensitive to their nature and presence. Stated differently, one aspect of the present disclosure involves a drilling tool assembly including sensors and processing electronics (e.g., the accelerometers and/or strain gauges in the bit sub 26 proximate the bit 22) that are positioned to detect and record the radiated waves from the drilling induced fracturing, which may further involve identification and/or characterization of existing mechanical discontinuities, such as fractures or geological boundaries, such as faults or bedding planes.

In one specific implementation, a form of measurement while drilling (MWD) system or tool is employed. The MWD system uses sensors designed to measure vibrations. The MWD system may also measure forces on the bit, and other parameters such as bit speed, which may be expressed as revolutions per minute, the fluid pressures, and temperature of the drilling mud or environment proximate the bit sub. The system may also include gyroscopes to obtain the orientation of the cutting face of the drill bit, in some implementations. In one specific embodiment, the MWD tool includes at least one receiver, accelerometers which may include strain gauges mounted on or proximate the bottom hole assembly to record the drilling vibrations and associated acoustic emissions. In some implementations, the MWD may further include electrical, mechanical, and/or other filtering mechanisms to processes the data to remove unwanted noise or to record the data without unwanted noise. In certain instances, stages of filtering may be applied both prior to recording, and after recording but prior to processing, to remove unwanted data, or as much as necessary or possible. In an alternative enablement, the signals may be transmitted to the surface for storage and processing. In some applications it may be desirable to process the acoustical signals, such as through the processor, on board the logging tool for transmission of the significantly data-reduced processed signal to surface in real time.

Once the drilling data is collected and processed, the results are correlated back to the measured depth of the well using precise measurements of the length of drill string components as they are lowered into the well. Gamma ray MWD and casing collar measurements can further be used to correlate the absolute location of data processed from the BHA collection point or points to determine a more reliable location of the bit in relation to the subsurface.

In accordance with various aspects of the present disclosure, mechanical rock properties, and more particularly rock strength properties, are obtained from the processing and analysis of forces and motions of a drill bit, or other component, interacting with a geological formation, such as a rock formation. The forces and motions may be measured from an arrangement of appropriate sensors, such as provided from the MWD apparatus positioned proximate the drill bit as discussed above. Such forces and motions may be measured continuously and at a high sample rate. The forces and motions are used to obtain, such as through Fourier transformations, spectral estimates of the forces and motions of the bit. The spectral estimates may then be used to construct innovative, new force-displacement diagrams representing the deformation and failure of a geological formation, such as a rock formation being drilled through for an oil or gas well, as a result of a drill bit interacting with the formation. The force-displacement diagrams are understood to represent the constitutive elastic and plastic behavior and the elastic-plastic transition of the material when being cut by a bit. By correlating information derived from the force-displacement diagrams, or more generally the pairs, with a location along the wellbore being drilled, it is possible to control and manage completion and subsequent other drilling operations in several ways.

The method further elaborates on objective techniques to obtain the point of the elastic-plastic transition from the force-displacement diagram and to further use the values of the forces and displacements at the elastic-plastic transition to obtain rock strength and other properties.

In one possible application, the use of the force-displacement construction is extended to include an innovative new way to construct a compliance-length diagram. The compliance length diagram can be used, in general, to determine the resistance of a rock formation to a propagating crack or in a particular application to obtain a fracture toughness which is a measure of the resistance to a propagating hydraulic fracture in connection with a well completion operation. Understanding the resistance of a formation to a propagating crack can be used to select hydraulic fracture entry points and thus used for casing and perforation determinations among other ways to use the information.

In general, the method to obtain the force-displacement diagram pertains to any piece of rotating machinery. For example, in the cases of a rotor supported by bearings, the force-displacement diagram obtained by continuous, high-resolution measurements would be related to the interaction of the rotating shaft with the bearing assembly. Variations in the force-displacement diagrams could be used to describe the deformation and failure of the bearings. Accordingly, while the methods discussed herein are primarily discussed relative to rock properties and drilling operations, the techniques have broad applicability in other fields.

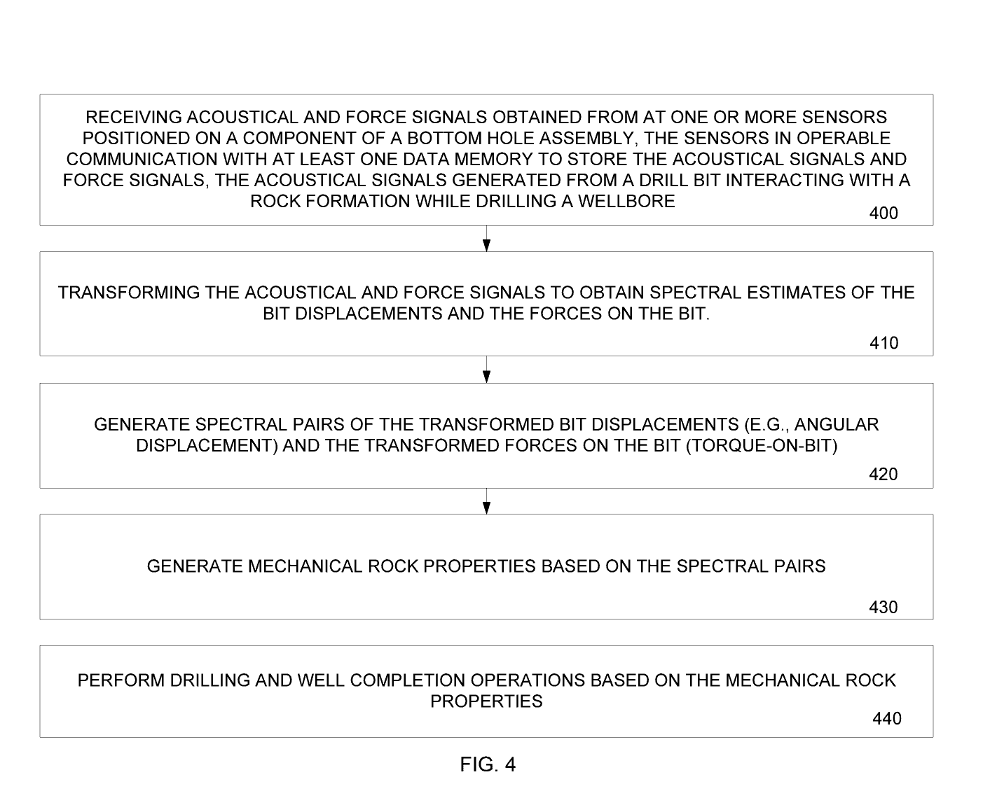

Referring now to FIG. 4, a flowchart of a method of obtaining rock strength properties is shown. As introduced above and referring to FIG. 2, MWD data can be recorded using downhole measurements made with strain gauges and accelerometers, among other things. For example, strain gauge measurements can be processed to obtain measurements of WOB and TOB. The measurements can be sampled continuously at high frequency and the measurements stored in a memory of the MWD recording apparatus. In another example, the motion (vibration) of the bit, while drilling, may be captured through an arrangement of accelerometers on the MWD recording system. The accelerometers may be arranged in orthogonal recording configurations that when combined together using addition and subtraction can be used to separate the angular (rotational) and linear motions of the bit. Thus, the method begins with receiving and storing, at and by a processor and an associated data memory, acoustical and force signals, in the time domain, obtained from the sensors of the MWD apparatus or otherwise (operation 400). Similarly, the method may begin with accessing, by the processor, time domain force and motion data collected from the sensors associated with a drill bit interacting with a rock formation while drilling a wellbore.

Processing, continuous high-frequency measurements while drilling (MWD) data in the manner described by the method provides innovative, new techniques to generate the constitutive relationships that can be used to obtain properties of mechanical rock strength that are useful to characterize the deformation and failure of a rock as it progresses from elastic to plastic behavior. In one embodiment, the constitutive relationship between the angular forces and angular motions of the drill, and mechanical rock strength properties of the rock formation being drilled through are used to predict the deformation and failure of the rock formation when subject to the forces associated with hydraulic fracture completion operations.

As introduced above in discussing FIGS. 3A-3C, a rock formation interacting with multiple cutters on a drill bit undergoes multiple modes of deformation simultaneously including both elastic and plastic behavior in the same instant of time. The deformation and failure of a rock formation is generally understood to involve (i) an initial loading and elastic deformation of the rock formation up to the point (ii) where the strain energy required to accommodate further deformation requires the onset of plastic deformation caused by activation of small dislocations in the rock matrix (iii) that localize into microcracks with dimensions on the order of micrometers that (iv) link together to cause through going shear fractures that undergo (v) shear displacements and ultimately (vi) the cataclysmic failure of the rock formation followed by (vii) unloading of the bit and (viii) the bit slipping along the new evacuated surface until which point (ix) the dislocation is arrested as the bit re-engages the rock formation at its cutting edge and repeat the process all over again. The onset of the elastic to plastic transition usually occurs with the activation of small dislocations. At any instant in time any one or more of the cutters may be engaged in any one or more of the behaviors that constitute the elastic deformation and plastic deformation or failure of the rock formation. Most of the cutting behavior of a rock is plastic deformation and the elastic deformation is small and on the order of micrometers.

The cutting face is understood to be defined by the distribution of area where the cutters are in contact with the rock formation. At the location of each cutter along the cutting face, the rock formation is experiencing either elastic or plastic behavior or the rock formation there is undergoing a transition between the two. As the bit turns, multiple modes of rock deformation and failure in relation to the cutting action of the bit are superimposed on each other through constructive and destructive interferences and the state of deformation in relation to each and every cutter is seemingly unknowable. Owing to the nature of the cutting action of the bit, the MWD records of the forces and the motion of the bit interacting with the rock formation have a chaotic, seemingly unpredictable character that makes it difficult to (i) not only separate the specific types behaviors describing the various components of rock deformation and rock failure, (ii) but also extract any meaningful information from the raw MWD records in relation to mechanical rock-strength properties of the rock formation. The techniques discussed herein are able to extract mechanical properties of the rock formation, such as the elastic plastic transition, from this chaotic soup of data captured from the multiple cutter heads individually interacting with the rock formation and each generating their own signals.

Referring again to FIG. 4, the method further involves transforming the acoustical and force signals to obtain spectral estimates of the motions and forces on the bit (operation 410). Despite the chaotic character of the data, techniques set out herein provide meaningful descriptions of rock strength through the application and use of geophysical signal processing techniques to transform the MWD data into novel and non-obvious, force-displacement diagrams, which may be correlated with a position of the bit in relation to the well bore to characterize the rock formation along the well bore. The force-displacement diagrams are analyzed to obtain a point at which the material deformation undergoes a transition from elastic and plastic behavior in response forces and motions of a drill bit when interacting on the rock formation. The transition from elastic to plastic deformation usually occurs when the rock begins to deform along discrete failure surfaces and is commonly referred to as the Initial Yield Strength (IYS). In the method provided here, innovative new techniques are used to obtain various different measurements of rock strength, along the well bore, using the forces on the bit and motion of the bit interacting with a rock formation at the point of elastic to plastic transition.

Referring to FIG. 4, the method, which may involve obtaining rock strength through the application and use of force-displacement diagrams, first involves collecting and storing vibration (acoustical) and force signals generated from the bit cutting the well bore into the formation (operation 400). The acoustical and force signals may be locally stored in a data memory associated with the BHA generally or the MWD apparatus more specifically, or any other device positioned to capture and record the data. Further processing may be necessary to convert the force and acoustical signals into representations of forces on the bit and accelerations of the bit. In one specific example, the forces on the bit of interest relate to TOB and the vibrations of the bit of interest relate to angular accelerations.

The method further involves transforming the data, which may be continuously sampled, high-rate MWD data, using geophysical signal processing techniques to (i) obtain the spectral estimates of the forces of the bit interacting on rock formation in connection with the drilling apparatus and drilling fluid system, and (ii) obtain the spectral estimates of the motions of the bit (displacements) in relation to the deformation and failure of the rock formation (operation 410).

The geophysical signal processing involves (i) obtaining a spectral representation of the forces acting on the rock formation in connection with the drilling apparatus, such as the TOB and WOB, and drilling fluid system such as the annular pressure and (ii) the displacement of the bit caused by the deformation and failure of the rock formation also as a function of frequency. In one example discussed herein, the spectral representations are generated for the TOB and angular displacement. Here geophysical signal processing uses techniques related to spectral estimation, such as Fourier transform methods, to obtain the amplitude spectra of the forces and displacements from the MWD data.

MWD systems capable of storing high-frequency data can be used in connection with the method, where the data is retrieved from the memory of the MWD system when the drilling operations have been completed and then subjected to further processing and analysis. The data may be stored in the time domain. Alternatively, onboard digital signal processing (DSP) of the data in accordance with the techniques presented here enables the method to be implemented at higher sample rates than can be currently afforded owing to the limitations and constraints of recording in hostile downhole environments. Hence, rather than storing time domain data for later retrieval, transformed motion and force data is stored for later retrieval and processing. In one possible embodiment, the MWD apparatus and the onboard DSP system are positioned near the bit to acquire the forces and motions of the bit interacting with a rock formation with less attenuation and noise as compared to a device where the MWD apparatus is positioned behind the mud motor or otherwise further from the drill.

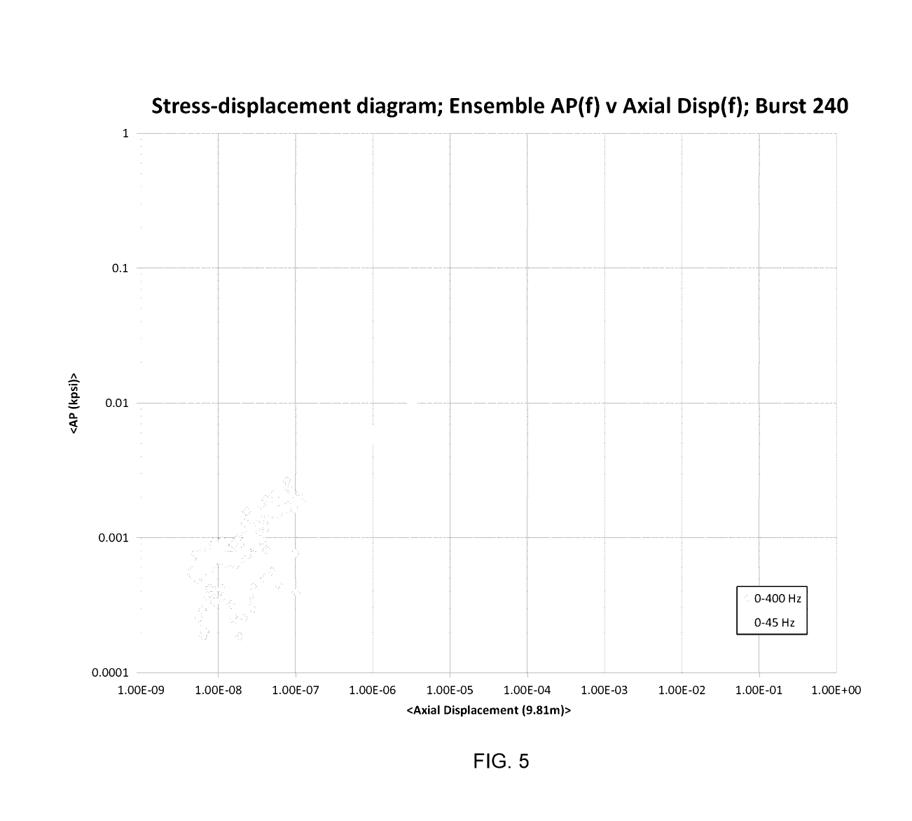

The displacement of the bit as a function of frequency can be calculated by integrating the acceleration spectra twice in the frequency domain to obtain the displacement spectrum. FIG. 5 illustrates a spectral estimate of the angular displacement spectra where the spectral estimate is obtained by processing an angular acceleration obtained by first sampling at a high rate either (i) a sensor sensitive to changes in the velocity or otherwise an accelerometer or (ii) a gyrometer or sensor sensitive to an angular velocity measurements, and then transforming the measurements into the frequency domain using Fast Fourier Transform (FFT) techniques. Other spectral estimation techniques such as wavelet transforms can also provide a basis to transform the time series data into the frequency domain. The angular displacement spectrum can be obtained by transforming the measurements of the gyrometer or angular velocity of the bit typically referred to in terms of revolutions per minute (RPM) into the frequency domain and then performing and integration of the angular velocity spectra to obtain the angular displacement spectra.

The estimates of the spectral amplitudes used to form the data pairs can be further improved by obtaining multiple consecutive Fourier transforms such as by using a time window corresponding to one turn of the bit and then averaging the amplitude spectra for each of the time windows to create spectral ensembles. In the spectral ensemble, multiple amplitude spectra describing the forces and displacements as a function of frequency are averaged for each frequency. Increasing the number of amplitude spectra used to generate the spectral ensemble reduces the variance in the spectral estimation and improves the spectral estimate by averaging out any noise in the measurements. The variance of the ensemble spectral estimate is expected to decrease by 9K/11 where K is the number of spectra used in the ensemble. The number of spectra used in the ensemble depends on the resolution of the smallest degree of heterogeneity that is wished to be resolved. The more spectra used to generate the ensemble represent more drilling time and will average heterogeneity of the mechanical rock strength properties. In practice the number of spectral data windows used to calculate the average or ensemble spectral may depend on the resolution of the lowest frequency needed to adequately describe the low frequency behavior of the rock formation.

Returning to FIG. 4, the spectral representations of the displacements and forces are paired according to frequency (operation 420). More particularly, a computing system, where the originally obtained drilling data is available and has been transformed, pairs the transformed force-displacement data by frequency to obtain a distribution, which may be a force-displacement distribution. Summarizing, the force-displacement diagram is constructed by (i) decomposing the MWD data into the spectral domain and (ii) then forming the spectral pairs between the forces and the displacements. Analyzing the distribution of the spectral pairs with stress-strain constitutive relationships provides a method to identify the transition between elastic and plastic behavior of the rock formation experienced by the cutting action of the bit.

Force-displacement pairs are made for each frequency using the amplitude or an ensemble of the appropriate amplitude spectra. For example, force-displacement data pairs may be comprised of a frequency pair of TOB (f) and angular displacement (f) or a frequency-pair or WOB (f) and axial displacement. FIG. 5 is a plot of the distribution of spectral pairs formed between the annular pressure and the axial displacement. The spectral pairs are formed from an ensemble average annular pressure spectra and ensemble average of the axial displacement spectra. In this case, the ensemble averages are formed by averaging 38 spectra. Each spectral estimate was obtained using a series of 512 sample windows lagged by 256 samples. On a log-log scale, the distribution of the spectral pairs forms a linear relationship suggesting that the distribution of spectral pairs between the annular pressure and axial displacement can be described using a power-law.

The distribution of force-displacement spectral pairs, in one example, is found to follow a constitutive relationship used to describe the deformation and failure of a wide range of materials known as the Holloman-Ludwig equation. This equation is conventionally used to parameterize stress-strain (force-displacement) curves in laboratory settings. In laboratory settings, the force-displacement pairs are obtained as a function of time (not frequency) and the power law relationship describes the distribution of the force-displacement in time as the rock deformation experiment progresses. Using a laboratory loading apparatus, a sample of material is subject to loading using a hydraulic press with gauges to measure the load applied to a sample. Strain gauges placed on the material (or sample) are used to measure the deformation for each load level. As the load increases, the deformation increases typically in accordance with the Holloman-Ludwig law.

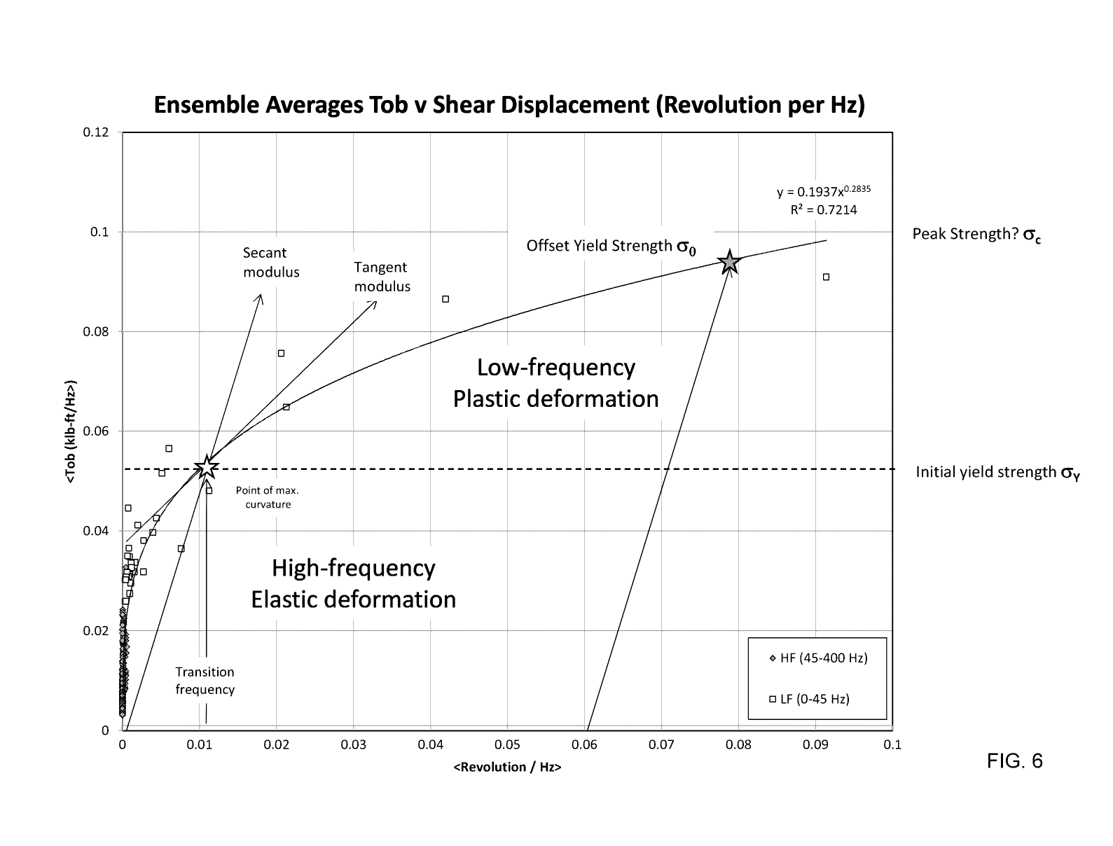

Referring again to FIG. 4, the distribution of spectral pairs may be used to generate and identify various possible rock properties (operation 430). FIG. 6 is a linear cross-plot of spectral pairs formed between ensemble average of the downhole measurements of TOB and angular displacements, and is one example of spectral pair distributions taking advantage of TOB and angular displacements. The distribution of spectral pairs can be described by the power-law relationship shown by the curved line. The force-displacement distribution may be analyzed using parametric relationships useful to describe the constitutive stress-strain behavior of a rock formation. In particular and in various examples, in reference to the force displacement diagram, Holloman-Ludwig power-law relationships may be used to represent the constitutive stress-strain behavior of the rock formation during deformation and failure associated with the cutting action of the bit, obtain mechanical rock-strength properties at the transition from elastic to plastic deformation of the rock formation in relation to (a) the IYS, (b) the angle of internal friction, (c) uniaxial compressive strength and uniaxial tensile strength (d) the secant modulus and tangent modulus, (e) an offset yield modulus, (f) peak strength, (g) the modulus of toughness or the work under the force-displacement curve, (h) the modulus of resilience, (i) the critical strain energy release rate and (j) the stress-intensity factor, any of which and others may be considered “Mechanical Rock Properties”.

Referring still to FIG. 6, at a point of maximum curvature of the line, a first star is taken to represent a point along the curvature representative of the transition between elastic and plastic deformation. The value of TOB at the first star is the IYS, which is discussed in more detail below. The tangent modulus is defined by the slope of the power-law curve at the first starred point, and the slope from the origin through the star is the secant modulus. A line drawn from any angular displacement on the x-axis parallel to the secant modulus to the intersection of the power-law curve is the offset yield modulus. In engineering nomenclature, the offset yield modulus is taken as the point of 0.02 strain. Because this is a force-displacement diagram, it is not possible to know the strain in relation to the angular displacement without assuming a reference length from which to compare against. In this case, the reference length is the solid angle of the bit or 2 pi or 6.28. Therefore, the point of 0.02 strain is found by dividing the angular displacement axis by 6.28.

In one particular aspect of the method, the distribution of the force-displacement pairs is analyzed using a linear power-law relationship of the form:

Force=C(Displacement)ⁿ

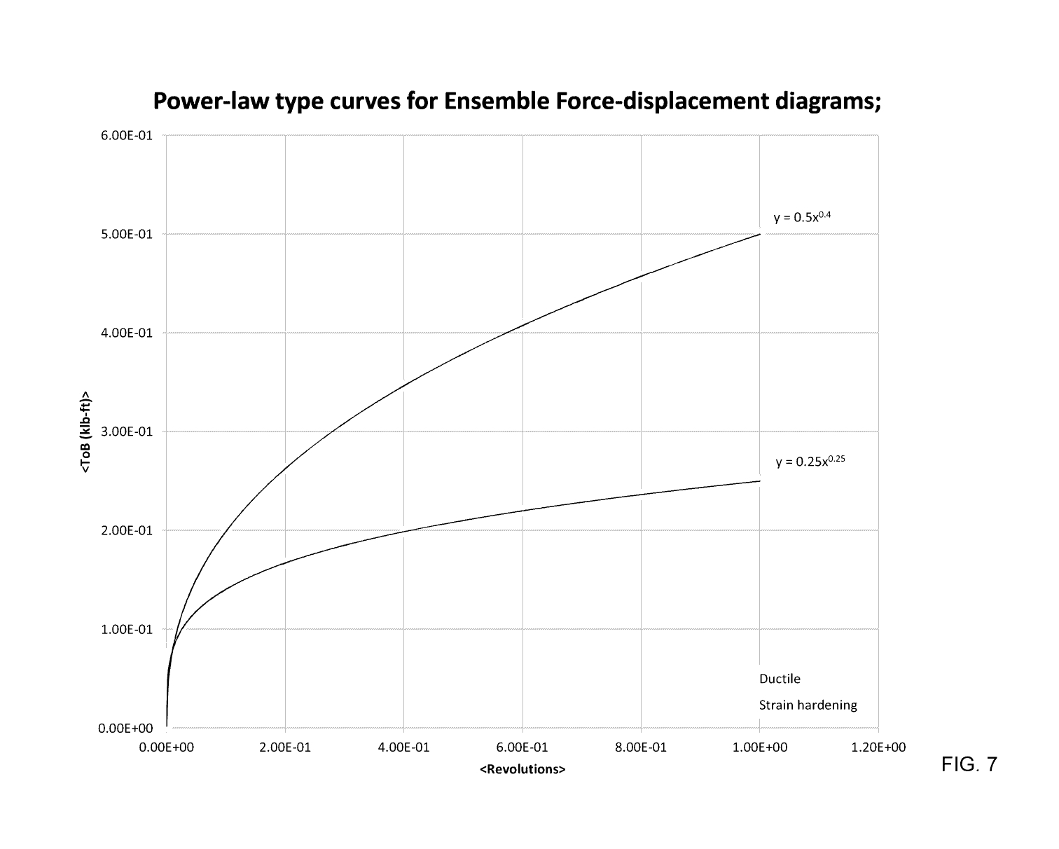

In a particular implementation, the force is given as a function of frequency by the spectral estimate of the TOB and the displacement is given as a function of frequency is the spectral estimate of the angular displacement of the bit. Here, geophysical processing of the MWD data is used to transform the forces on the bit and the motion of the bit in an unexpected way into a Holloman-Ludwig equation used to describe the nature of the deformation and failure of a wide range of materials including rock. The C coefficient is related to the material strength and the n exponent is often referred to as the strain hardening exponent.
FIG. 7 is a diagram illustrating a representation of power-law curves for various strength scalars and strain hardening exponents. A strain coefficient of zero (n=0) is for a perfectly plastic solid whereas as strain coefficient of (n=1) is for an elastic solid. Most materials exhibit a hardening exponent between 0.25 and 0.5 when undergoing deformation that involves a transition from elastic-plastic behavior as shown in FIG. 5.

The spectral frequency pairs naturally distribute into a constitutive relation describing the deformation and failure of the rock formation in relation to the forces and motions on a drill bit interacting with a rock formation. While not being constrained by theory, it is believed that this is possible through the method described here, because the higher frequencies represent early times associated with onset of loading and small displacements associated with elastic deformation, while the lower frequency data pairs represent the forces and motions at later times and plastic deformation up until after rock failure. The transition between these two types of constitutive behavior is often referred to as the elastic-plastic transition, and the captured data and processing of the same includes elastic deformation, plastic deformation and the transition there between.

Further, the point of maximum curvature also determines the frequency in the data at which the elastic to plastic transition occurs. Note that the frequency of the data is not used to obtain the point of maximum curvature only that the distribution of the spectral pairs with respect to power law are used to determine this point and it is not obvious that (i) the spectral pairs obtained in this manner should follow the power law constitutive behavior observed in laboratory material deformation experiments (ii) it is only through a high-rate near-bit MWD recording apparatus that this relationship is possible, and (iii) that the IYS is determined as the value of the torque-on-bit (TOB) at the point of maximum curvature.

As deformation of the rock formation progresses, there is increasing displacement, which is accommodated by increasingly inelastic or plastic behavior that results from the initiations and propagation of fractures ultimately leading to failure of the rock formation. The mechanical rock-strength property that relates to the transition between elastic and plastic (sometimes referred to incorrectly as the brittle-ductile transition) is often referred to as the Initial Yield Strength of the rock formation and occurs at the onset of critical fracture propagation. The determination of the IYS from the constitutive stress-strain relationship provided in connection with a high rate MWD recording apparatus and/or DSP processing system according to the method provides innovative, new techniques to obtain mechanical rock properties. The data set captured should cover sufficient rotation of the drill bit to capture data representative of the elastic, plastic and transitions between elastic and plastic behavior. The rotation may be less than one complete revolution of the bit.

According to the method discussed herein, an objective way to separate the elastic and plastic regions and obtain the elastic-plastic transformation of the force-displacement diagram would be to calculate the point of maximum curvature of the power-law relationship used to describe the distribution of the force-displacement data pairs. The coefficients of the power-law or Holloman-Ludwig relationship can be obtained by (i) transforming the spectral data pairs using a log-log transformation and (ii) using linear regression techniques to find a line that describes the log-log transformed data pairs where the strain hardening coefficient is related to the slope of the line and the strength coefficients is related the intercept of the line. The point of maximum curvature can be obtained by taking the derivative of the equation that describes the curvature of a line in relation to the power-law and setting the value of that derivative function to zero. The point may also be determined by identifying the WOB value from the closest measured spectral pair to the computed maximum curvature.

The frequency that corresponds to the data pair at the point of maximum is used to select the value of the torque at the transition between the elastic and plastic deformation. The value of this particular torque value obtained in this method is understood to be the IYS of the rock and the angular displacement is understood to be a critical displacement as evidenced by the forces on the bit and the motion of the bit while interacting with a rock formation.

Because analytic expressions for the point of maximum curvature only exist when values of the strain hardening exponent are less than 0.5 (<0.5), other techniques are provided to estimate the transition between elastic and plastic deformation in cases when the strain hardening exponent is greater than 0.5 (>0.5).

Because the transition between elastic and plastic behavior can sometimes be gradual it is often difficult in practice to determine when this behavior actually starts. In extreme examples of rapid, brittle failure, the transition is easy to recognize because there is the rapid development of a through-going fracture and subsequently catastrophic failure of the rock formation. In engineering studies, the elastic-plastic transition is often picked at a constant strain increment (0.2% stain), and this offset yield strength is then generally accepted as the IYS. This practice enables a common point of departure from which to compare constitutive stress-strain behaviors among a variety of materials.

For rock being drilled at depth and therefore typically at high-confining pressure, the rock deformation behavior is more often ductile than brittle and this ductility results in a gradual flattening to the slope of the force-displacement curve with decreasing frequency or longer periods of the bit interacting with the rock. This type of behavior lends itself naturally to a technique where the point of maximum curvature on the force-displacement curve can be used to determine the IYS. In addition, the offset yield stress at a given turn of the bit or for example a 0.2% percentage of a revolution can also be used to approximate the IYS from the force-displacement diagram as constructed in the manner presented here.

Once the IYS has been recognized, either by the point of maximum curvature, some description of offset yield strength, or otherwise then the other forces at the point of the elastic-plastic transition are obtained by taking the values of WOB or Annular pressure corresponding to that frequency from the spectral estimation of the WOB or Annular pressure. In constructing the force-displacement diagram it is understood that the TOB is acting as a body force or principal force and the angular displacement is acting as a normal displacement or principal displacement. However, once the deformation of the rock formation has moved beyond the IYS it is understood to be undergoing plastic deformation. Here, in the lower-frequency regime, the angular displacement becomes a shearing displacement and is no longer a principal motion.

As discussed above, in one example, the IYS is identified as the value of the TOB at the point of maximum curvature of the force displacement diagram based on a distribution of the spectra for TOB and angular displacements. The point of maximum curvature as previously described can be obtained in one example by using regression techniques to find the power-law curve that best describe the distribution of spectral pairs. In one example the data pairs are obtained by the spectral estimation of the TOB and angular displacement measurements.

By obtaining the frequency of which the point of maximum curvature occurs it is also possible to obtain the other values of the forces such as the WOB and/or the annular pressure value at the point of the elastic-plastic transformation or at the same frequency as the IYS. Stated differently, obtaining the IYS using only the distribution of the TOB and angular displacement spectral pairs to obtain the point of transition from elastic to plastic deformation can provide estimates of the other forces and motions of the bit interacting with the rock formation at the elastic-plastic transition.

Because the values of IYS are obtained when the rock deformation transitions from elastic to plastic deformation as evidenced by the power-law distribution of the TOB and angular displacement spectral pairs, it is understood that in relation to the method that the IYS is related to the maximum principal stress at failure and the amplitude of the WOB or AP spectra at that the elastic-plastic transition would be understood to be related to the confining pressure exerted by the bit on the rock formation at failure. In relation to the method, the TOB value when normalized by the contract area of the bit would correspond to the principle stresses sigma one and the WOB or annular pressure value at the frequency of maximum curvature when normalized by the contact area of the bit would correspond to sigma three.

Values of sigma sub 1 and sigma sub 3 obtained by this method can be analyzed in terms of a rock failure model generally known Coulomb strength profile according to the following, while drilling a well. The forces and motions from multiple turns of the bit are observed by the high-rate MWD recording apparatus while drilling a well. For each turn of the bit, the principal stresses at the transition between the elastic and plastic deformation can be determined according to the method. The principal stresses, sigma sub 1 and sigma sub 3, obtained for each turn of the bit can be plotted on a diagram. The distribution of data principal stresses defines a failure envelope known as the Coulomb strength envelop in terms of principal stresses.

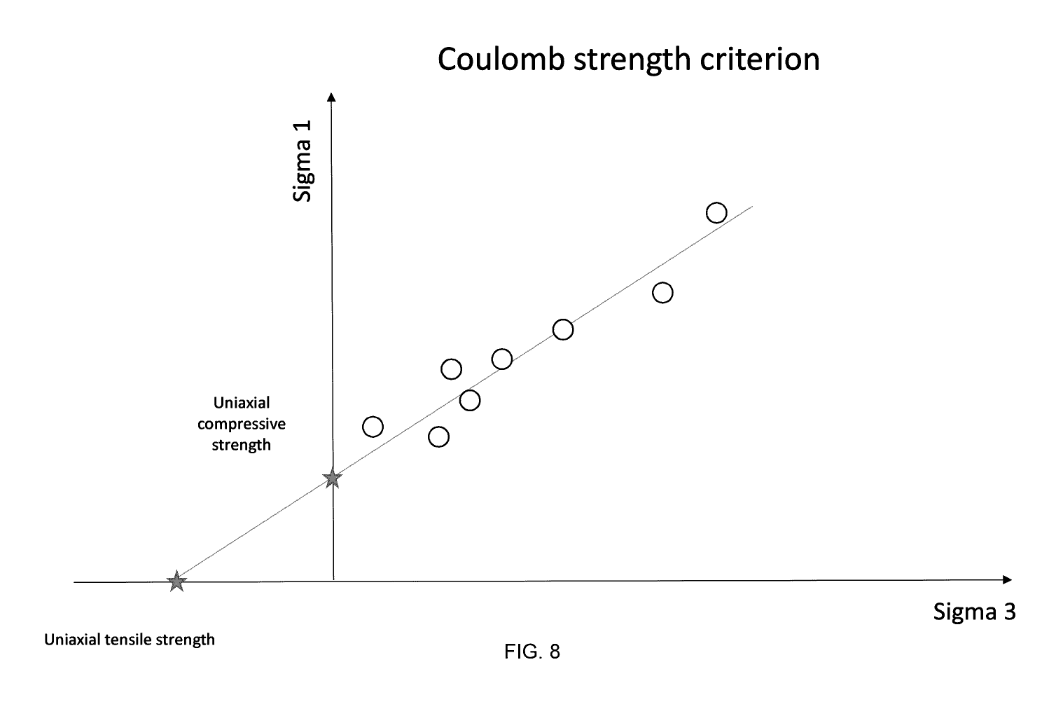

The principle stresses obtained from IYS and confining pressure can be used in terms of a Coulomb shear strength criterion to define a failure envelope. FIG. 8 is a plot of sigma sub 1 versus sigma sub 3, providing a Coulomb strength criterion. Construction of a Coulomb strength criterion using MWD measurements, for each turn of the bit or each consecutive window of drilling data, involves (i) obtaining a distribution of spectral pairs and in particular where the spectral pairs are formed between the TOB and the angular-displacement spectra at each frequency, (ii) obtaining the point of maximum curvature at the point of transition between elastic and plastic deformation, (iii) obtaining the frequency at the point of maximum curvature, (iv) obtaining the TOB at, or very near, the point of maximum curvature, (iv) using the frequency at the point of maximum curvature to select the spectral amplitude of the WOB at the frequency, (v) plotting at least two estimates of the TOB and WOB at the frequency of maximum curvature and (iv) obtaining the parameters to a line describing the relationship between the two points where the intercept of the sigma 1 axis is the uniaxial compressive strength and the intercept with the sigma 3 axis is the uniaxial tensile strength. The failure envelope is linear in relation to the principle stresses where the slope of the principle stress failure envelope (phi) can be related to the angle of internal friction (theta) according to:

Tan phi=(1+sin theta)over(1−sin theta)

The intercept of the principle stress failure envelope when the confining pressure is zero is the uniaxial compressive strength of the rock formation. The uniaxial compressive strength of the rock formation Sigma sub c can be related to both the internal cohesion and angle of internal friction through:

Sigma sub c=2*cohesion cos theta over(1−sin theta)

If the Coulomb envelope is extrapolated to sigma sub 1 equal zero, then it will intersect the sigma sub 3 axis at an apparent value of the uniaxial tensile strength of the material.

Processing the MWD data in the manner described above at the point of maximum curvature enables the estimation of mechanical rock-strength properties in relation to the angle of internal friction and uniaxial compressive strength of the rock and the uniaxial tensile strength of the rock.

The Peak Yield Strength is not necessarily the same as the IYS, though in terms of the constitutive behavior in terms of the force-displacement curves peak yield strength can be approximated as an offset yield strength where the offset yield corresponds to the maximum deformation that can be sustained by the rock formation.

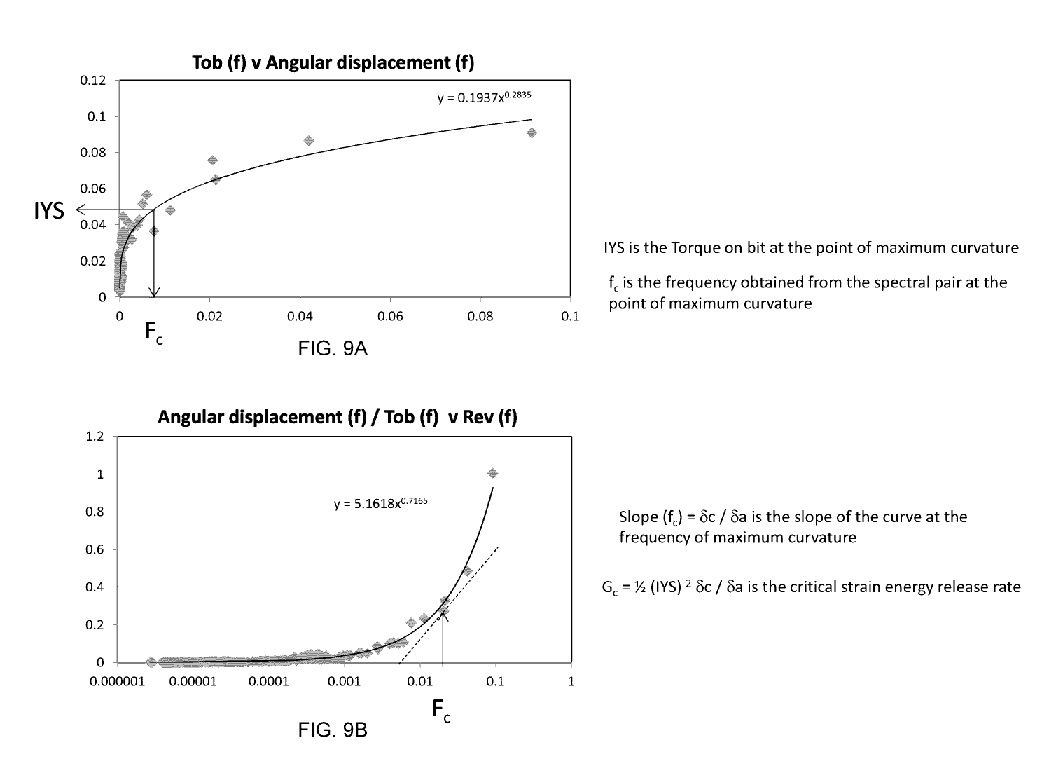

Another measure of rock strength is the ability of the rock to resist propagation of a fracture. In some instances, this is referred to as fracture toughness. In one embodiment of the method, the ability of a rock to resist the cutting action of the bit can be obtained by further extending the method of constructing a force-displacement diagram in order to construct a compliance-length diagram as shown in FIG. 9B, which is based on the force displacement diagram depicted in FIG. 9A. The compliance is the ratio of deformation to applied load. In a particular example, the deformation is the angular displacement of the bit and applied load is the TOB. The compliance as a function of length can be constructed in connection with high-rate MWD recording apparatus. A method to obtain fracture toughness, using a computing device, through the application and use of force-displacement and compliance-length diagrams involves transforming continuous high-rate MWD data using geophysical signal processing techniques to (i) obtain the spectral estimates of forces of the bit interacting on rock formation in connection with a drilling apparatus and drilling fluid system, (ii) obtain the spectral ensemble of the motions of the bit displacements in relation to the deformation and failure of the rock formation, (iii) pair force-displacement points by frequency for each frequency to obtain a force-displacement distribution, (iv) analyze the distribution of the force-displacement pairs using parametric relationships useful to describe the constitutive stress-strain behavior of a rock formation (v) and in particular use a power-law relationship in the form of the Holloman-Ludwig relationship to fit a curve to the force displacement pairs thereby representing the constitutive stress-strain behavior of the rock formation during deformation and failure associated with the cutting action of the bit, (vi) obtain the point of elastic-plastic deformation from the maximum curvature of the power law relationship, (vii) obtain the initial yield strength from the amplitude of the torque-on-bit spectra at the point of maximum curvature, (viii) obtain the displacement at the point of maximum curvature, (ix) obtain the frequency of the point of maximum curvature, (x) pair compliance-length points by frequency at each frequency to obtain a compliance-length distribution, (xi) analyze the distribution of the compliance-length pairs using parametric relationships useful to describe the strain energy release rate of a rock formation, (xii) and in particular use a power-law relationship to represent the distribution of the compliance-length data pairs, (xiii) obtain the slope of the compliance-length power law relationship evaluated at the frequency of maximum curvature from the force-displacement relationship, (xiv) obtain the critical strain energy release rate as:

$${G}_{c} = \frac{1}{2} {IYS}^{2} ( dc / da )$$

The critical strain energy release rate is related to the critical load or the IYS required to propagate a fracture of length given by the angular displacement at the point of transition between the elastic and plastic deformation. The critical energy release rate G sub c can be related to the fracture toughness parameter K as:

K=\sqrt{EG_{c}}

Where E is the Young's modulus of elasticity in the case of plane stress.

### Other Modulus

The modulus of toughness can be calculated as the area under the force-displacement curve described by the distribution of all spectral pairs that correspond to all frequencies below the point of elastic plastic transition or the mode of deformation and failure that is governed by plastic deformation where the onset of plastic deformation can be determined from the point of maximum curvature and the modulus of resilience is the area under the force-displacement curve corresponding to elastic deformation, where the elastic limit can be determined as the area under the curve described by the distribution of all spectral pairs that correspond to frequencies higher than the frequency of maximum curvature or all frequencies higher than the point of elastic plastic transition. The area under the curves can be determined by integration.

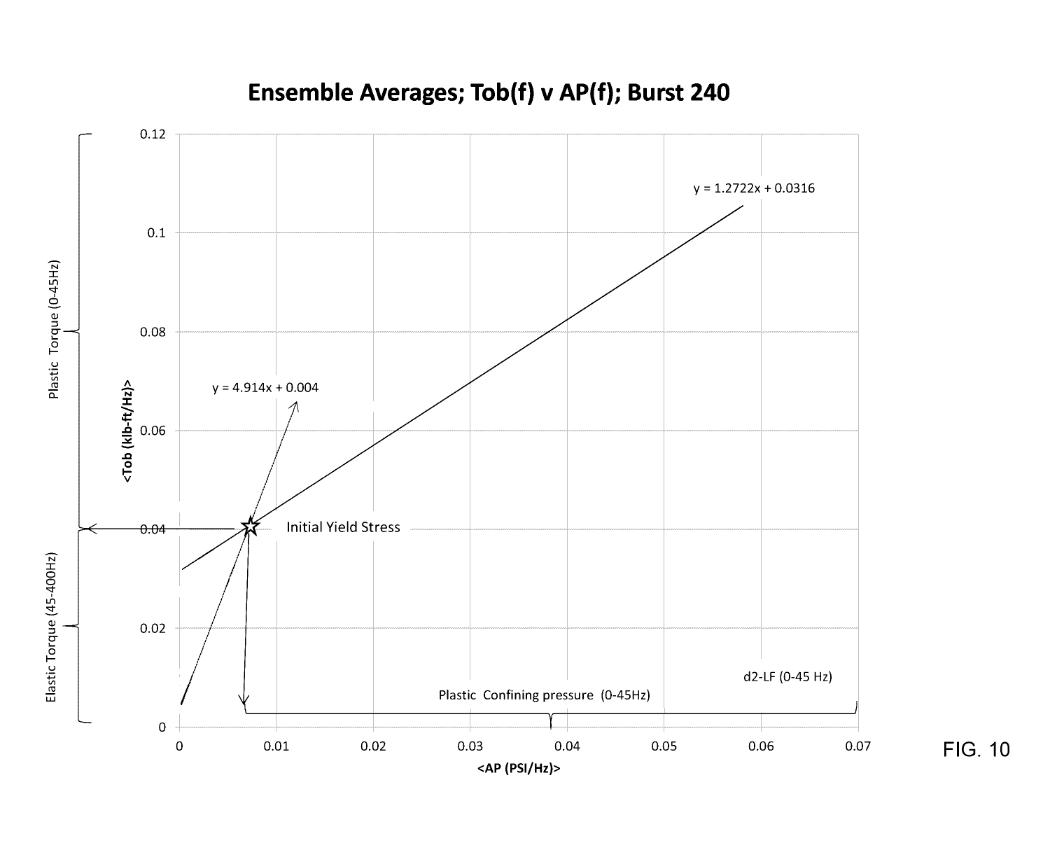

In instances with the strain hardening coefficient, n, is greater than 0.5 then there is no point of maximum curvature for a power law-relationship. In another example, to determine the point of elastic plastic deformation when there is no point of maximum curvature, two lines are fit to the distribution of spectral pairs. This is known as a bi-linear approximation. The bilinear approximation is accomplished by fitting a line to the spectral pairs that are (i) below a critical strain which can be informed by a frequency of the spectral pairs and by fitting a line to the spectral pairs below a critical strain which can be informed by a certain frequency of the spectral pairs. More specifically, referring to FIG. 10, a geometrical method to determine the IYS from the point of intersection (at the star) of the high-frequency and low-frequency data can also be envisioned. In this example, the graph represents a distribution of ensemble averages for TOB and Annular Pressure. The low frequency data distribution, represented by the rotated squares, generates a first line and the high frequency data distribution, represented by squares, generates a second line. The intersection of the first line and the second line, at the star, value of TOB at the intersection is taken as the IYS. In this example the distribution of low frequency spectral pairs corresponds to values below 45 Hz and the high frequencies distribution of spectral pairs corresponds to the spectral pairs formed at frequencies above 45 Hz.

Referring again to FIG. 4, the rock properties obtained by the method discussed herein may be used in various possible drilling and completing operations (operation 440). A force-displacement curve for brittle rocks is typically linear over the entire range where catastrophic failure occurs before the onset of any appreciable plastic deformation. The concept of brittle rock behavior can be expressed through the mechanical rock-strength properties in a variety of ways. In the simplest case the coefficients of the power-law fit to the force-displacement diagram provide a key diagnostic between brittle and ductile behavior where higher hardening coefficients corresponds to increasingly brittle behavior.

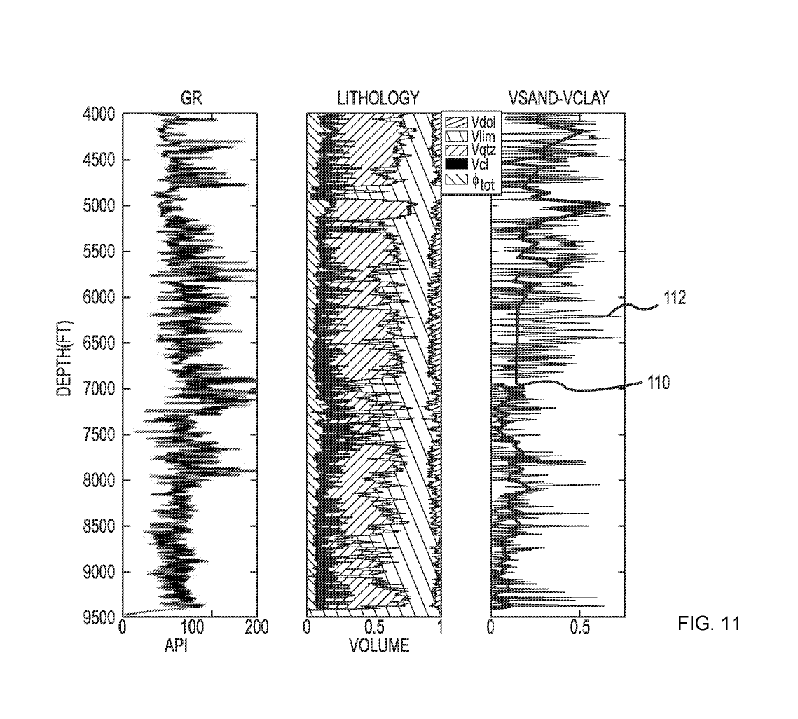

The coefficients of the Holloman Ludwig equation C and n are found to correspond to Vsand−Vlclay as shown in FIG. 11. The coefficients of C and n are related to the IYS where the coefficients are used to determine the point of maximum curvature from a force-displacement diagram from which the IYS is obtained as the TOB at the point of maximum curvature. The first curve 110 in FIG. 11 shows the IYS plotted against the Vsand−Vclay relationship shown as the second curve 112. Where there is a high IYS the value of Vsand−Vclay increases and conversely a low value of IYS corresponds to low values of Vsand−Vclay. In this example higher values of IYS indicate that the cutter is interacting with more brittle rock in this particular section of the wellbore. These zones may provide intervals that promote preferential hydraulic fracture growth in accordance with the description in FIG. 1A. The lower values of IYS and subsequently lower values of Vsand−Vclay would be understood to promote less efficient fracture growth and the creation of smaller fracture area during hydraulic fracture completion operations and lower reservoir performance.

The IYS can be used to describe the forces sufficient to initiate failure in a rock formation. When constructed in the manner described here, its calculation provides a high-resolution continuous strength profile along the length of the borehole that can be used to characterize geological heterogeneity in order to understand production variability. Rapid changes in strength may be indicative of the locations of weak rock formations where the rock formations may contain numerous fractures. Systematic identification of strong and weak zones and brittle and ductile zones along the length of a lateral can be used to identify and group perforation locations in the stimulation and treatment of unconventional resources.

The IYS may be used to identify the locations within an unconventional reservoir likely to initiate fractures in relation to the emplacement of hydraulic fractures during a hydraulic fracture stimulation treatment operation. For example in a plug and pert, an interval of the well is isolated using packers. These packers would ideally be set in zones of high yield strength to ensure that the inflation of the packers and the pressures used to hold it in place would not cause the rock formation to failure and provide a means for the fluids to bypass and escape from the interval or stage being pumped into. In another application, because of the natural heterogeneity within the rock formation or unconventional reservoir, the stage would consist of rock type with varying initial yield stress, where zones with low yield strength would be understood to provide preferential zones to target stimulation and treatment through the selection of perforations. It would be preferred to target zones for perforations that had the same or similar initial yield strength. Zones of lower yield strength would be easier to break and preferred locations for perforations than zones with high IYS. By placing all the perforations in a stage into rock with similar yield strength, this would ensure that all hydraulic fractures would initiate simultaneously at and roughly the same time and propagate in a similar way. Further, during pumping operations, fluid pressures are expected to vary as the viscosity of the fluid is changed with the introduction of proppant. The proppant is understood to embed itself in the newly formed fractures to prop or otherwise keep it open. Changes in pressure or decreases in pressure during a pumping operation would cause the rocks with perforations placed in higher yield strength rock to close off and the fluid would preferentially continue to flow into the rocks with the lower yield strength and create an uneven distribution of propped fractures along the length of the well.

Most unconventional reservoirs typically act as elastic brittle materials during the emplacement of hydraulic fractures. The fracture toughness can be understood in terms of the critical strain energy release rate or the critical stress intensity factor which can be related to the IYS. As the fracture toughness increases, it requires greater pumping pressures to propagate a fracture. In similar plug and perf completion designs it would be desirable to have all the perforation locations grouped into rocks with similar toughness so that pressure drops during pumping operations would not cause preferential flow in the fluids into the hydraulic fractures initiated in rocks with lower fracture toughness. This would help promote uniform fracture geometries and uniform fracture heights within a stage along the length of a lateral.

If in the case an operator were to place just one perforation in an interval with a low fracture toughness and the remaining perforations in locations with higher fracture toughness, if the pumping pressures decreased during the course of a job in a stage such that the perforations in the zones with higher fracture toughness were unable to continue to propagate in relation to the drop in pressure, the fluids would preferentially flow to the single perforation in the low fracture toughness interval, causing a runaway frac or a super frac to occur. This super frac may grow large through the reservoir and intersect other offset wells in the same formation nearby and cause detrimental production changes in these wells.

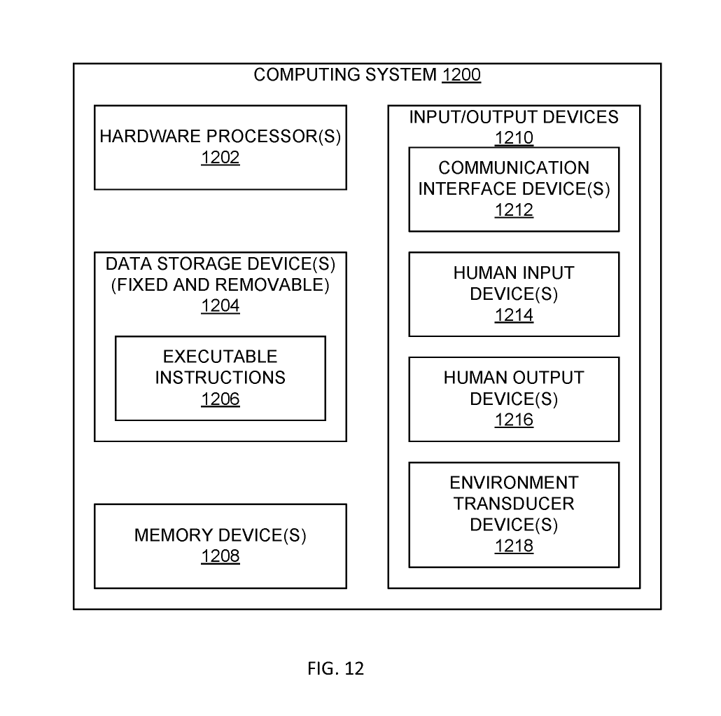

FIG. 12 is a block diagram of a machine in the example form of a computer system 1200 within which instructions 1206 for causing the machine to perform any one or more of the methodologies discussed herein may be executed by one or more hardware processors 1202. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines or controllers that individually or jointly execute a set (or multiple sets) of instructions 1206 to perform any one or more of the methodologies discussed herein, including that set out in FIG. 4 as well as the various methodologies discussed herein to obtain and compute, axial displacement, rotary displacement, axial and rotary accelerations, bit displacement, force measurements, spectral pairings, force displacement distributions, and various rock strength properties derived therefrom, as well as methods to use the rock strength properties in various possible ways including completions, fracture identification, packer placements, drill bit steering and others.

As depicted in FIG. 12, the example computing system 1200 may include one or more hardware processors 1202, one or more data storage devices 1204, one or more memory devices 1208, and/or one or more input/output devices 1210. Each of these components may include one or more integrated circuits (ICs) (including, but not limited to, field-programmable gate arrays (FPGAs), application-specific ICs (ASICs), and so on), as well as more discrete components, such as transistors, resistors, capacitors, inductors, transformers, and the like. Various ones of these components may communicate with one another by way of one or more communication buses, point-to-point communication paths, or other communication means not explicitly depicted in FIG. 12. Additionally, other devices or components, such as, for example, various peripheral controllers (e.g., an input/output controller, a memory controller, a data storage device controller, a graphics processing unit (GPU), and so on), a power supply, one or more ventilation fans, and an enclosure for encompassing the various components, may be included in the example computing system 1200, but are not explicitly depicted in FIG. 12 or discussed further herein. Aspects of the computing system may be integrated in a measurement while drilling apparatus or otherwise included in a drilling tool.

The at least one hardware processor 1202 may include, for example, a central processing unit (CPU), a microprocessor, a microcontroller, and/or a digital signal processor (DSP). Further, one or more hardware processors 1202 may include one or more execution cores capable of executing instructions and performing operations in parallel with each other. In some instances, the hardware processor is within the bit sub, and others it is part of another separate processing system.

The one or more data storage devices 1204 may include any non-volatile data storage device capable of storing the executable instructions 1206 and/or other data generated or employed within the example computing system 1200. In some examples, the one or more data storage devices 1204 may also include an operating system (OS) that manages the various components of the example computing system 1200 and through which application programs or other software may be executed. Thus, in some embodiments, the executable instructions 1206 may include instructions of both application programs and the operating system. Examples of the data storage devices 1204 may include, but are not limited to, magnetic disk drives, optical disk drives, solid state drives (SSDs), flash drives, and so on, and may include either or both removable data storage media (e.g., Compact Disc Read-Only Memory (CD-ROM), Digital Versatile Disc Read-Only Memory (DVD-ROM), magneto-optical disks, flash drives, and so on) and non-removable data storage media (e.g., internal magnetic hard disks, SSDs, and so on).

The one or more memory devices 1208 may include, in some examples, both volatile memory (such as, for example, dynamic random access memory (DRAM), static random access memory (SRAM), and so on), and non-volatile memory (e.g., read-only memory (ROM), flash memory, and the like). In one embodiment, a ROM may be utilized to store a basic input/output system (BIOS) to facilitate communication between an operating system and the various components of the example computing system 1200. In some examples, DRAM and/or other rewritable memory devices may be employed to store portions of the executable instructions 1206, as well as data accessed via the executable instructions 1206, at least on a temporary basis. In some examples, one or more of the memory devices 1208 may be located within the same integrated circuits as the one or more hardware processors 1202 to facilitate more rapid access to the executable instructions 1206 and/or data stored therein.

The one or more data storage devices 1204 and/or the one or more memory devices 1208 may be referred to as one or more machine-readable media, which may include a single medium or multiple media that store the one or more executable instructions 1206 or data structures. The term “machine-readable medium” shall also be taken to include any tangible medium that is capable of storing, encoding, or carrying instructions 1206 for execution by the machine and that cause the machine to perform any one or more of the methodologies of the present invention, or that is capable of storing, encoding, or carrying data structures utilized by or associated with such instructions 1206.

The input/output devices 1210 may include one or more communication interface devices 1212, human input devices 1214, human output devices 1216, and environment transducer devices 1218. The one or more communication interface devices 1212 may be configured to transmit and/or receive information between the example computing system 1200 and other machines or devices by way of one or more wired or wireless communication networks or connections. The information may include data that is provided as input to, or generated as output from, the example computing device 1200, and/or may include at least a portion of the executable instructions 1206. Examples of such networks or connections may include, but are not limited to, Universal Serial Bus (USB), Ethernet, Wi-Fi®, Bluetooth®, Near Field Communication (NFC), and so on. One or more such communication interface devices 1212 may be utilized to communicate one or more other machines, either directly over a point-to-point communication path or over another communication means. Further, one or more wireless communication interface devices 1212, as well as one or more environment transducer devices 1218 described below, may employ an antenna for electromagnetic signal transmission and/or reception. In some examples, an antenna may be employed to receive Global Positioning System (GPS) data to facilitate determination of a location of the machine or another device.

In some embodiments, the one or more human input devices 1214 may convert a human-generated signal, such as, for example, human voice, physical movement, physical touch or pressure, and the like, into electrical signals as input data for the example computing system 1200. The human input devices 1214 may include, for example, a keyboard, a mouse, a joystick, a camera, a microphone, a touch-sensitive display screen (“touchscreen”), a positional sensor, an orientation sensor, a gravitational sensor, an inertial sensor, an accelerometer, and/or the like.

The human output devices 1216 may convert electrical signals into signals that may be sensed as output by a human, such as sound, light, and/or touch. The human output devices 1216 may include, for example, a display monitor or touchscreen, a speaker, a tactile and/or haptic output device, and/or so on.

The one or more environment transducer devices 1218 may include a device that converts one form of energy or signal into another, such as from an electrical signal generated within the example computing system 1200 to another type of signal, and/or vice-versa. Further, the transducers 1218 may be incorporated within the computing system 1200, as illustrated in FIG. 12, or may be coupled thereto in a wired or wireless manner. In some embodiments, one or more environment transducer devices 1218 may sense characteristics or aspects of an environment local to or remote from the example computing device 1200, such as, for example, light, sound, temperature, pressure, magnetic field, electric field, chemical properties, physical movement, orientation, acceleration, gravity, and so on. Further, in some embodiments, one or more environment transducer devices 1218 may generate signals to impose some effect on the environment either local to or remote from the example computing device 1200, such as, for example, physical movement of some object (e.g., a drill bit interacting with a formation), receiving or processing accelerometer data, strain gauge data, gyroscopic data, and the like.

### SUMMARY

As such, under the aforementioned considerations the spatial variations in the MWD data in in particular the MWD vibrations as obtained through a combination of one or more of the measurements are used to describe variations in mechanical rock properties where the variations and occurrences of the can be described as fractures based on the methods used here. Here calculations made using signal processing techniques are used to generated force displacement distributions among other useful representations of spectral pairings, from which mechanical rock strength properties may be derived for a formation along a well bore and otherwise.

The method discloses how the spatial variations in one or more or a combination of the mechanical rock properties as can be obtained from the rock strength properties used to identify the nature and occurrence of fractures, fracture swarms and other mechanical discontinuities (boundaries) such as bedding planes and/or faults that offset or otherwise separate rock formations with different mechanical rock properties.

The present disclosure uses an innovative, new methodologies to determine the deformation of a rock formation by systematically relating forces acting on a rock formation in connection with the drill bit and drilling fluid system to the geophysical signal processing of drilling forces and motions generated by the fracturing of the rock in response to the cutting action of the bit to obtain a strain measurement. This approach allows spectral representations of the force and motion data to be used to identify rock strength properties of a formation through which a drill bit drills a well bore.

Methods that can in general understand and predict the nature and occurrence of fracturing along a wellbore are important considerations for the specification and design of hydraulic fracture stimulation techniques because decisions to either eliminate zones that do not experience brittle deformation or select zones that exhibit more brittle deformation relative to other zones can be used to improve the economics of the production. Further where the rock deformation is accommodated by failure of pre-existing fractures, these pre-existing fractures should be avoided when setting packers during the pumping operations or they can be targeted for hydraulic fracture stimulation depending on the desired approach to be used when completing the well.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of characterizing rock strength properties comprising:
accessing, by a processor, time domain force and motion data collected from sensors associated with a drill bit interacting with a rock formation while drilling a wellbore;
accessing, by the processor, spectral pairings generated from transformations of the time domain force and motion data; and
generating, by the processor, a rock strength property from a distribution of the spectral pairings.

2. The method of claim 1 wherein the time domain force and motion data is collected during a rotation of the drill bit where the rock formation experiences elastic and plastic deformation from the drill bit interacting with the rock formation while drilling the wellbore.

3. The method of claim 1 wherein the distribution is in the form of a force displacement representation from the spectral pairings, the force displacement used to identify the rock strength property for the rock formation in a location along the wellbore where the time domain force and motion data was collected.

4. The method of claim 1 wherein accessing, by the processor, spectral pairings from transformation of the time domain force and motion data comprises transforming, by the processor, the time domain forces and motions data to generate spectral pairings of force amplitude and motion amplitude.

5. The method of claim 4 wherein the time domain force data is torque-on-bit data, and the time domain motion data is angular acceleration data.

6. The method of claim 1 wherein the rock strength property includes at least one of initial yield strength, secant modulus, and tangent modulus.

7. The method of claim 1 wherein:
the time domain force data is torque-on-bit data, and the time domain motion data is angular acceleration data;
accessing, by the processor, spectral pairings generated from transformations of the time domain force and motion data comprises accessing spectral pairings generated from transformations of the torque-on-bit data and the angular acceleration data;
the method further comprising, identifying, using the processor, identifying a point of maximum curvature of a distribution of the spectral pairings, the distribution representing a force displacement diagram;
identifying a weight-on-bit force associated with the point of maximum curvature, the weight-on-bit at the point of maximum curvature indicative of a confining force.

8. The method of claim 1 wherein accessing, by the processor, spectral pairings generated from transformations of the time domain force and motion data further comprises transforming, using a processor to apply a Fourier transform, the time domain force and motion data into the spectral pairings.

9. The method of claim 1 wherein the sensors include a strain gauge and an accelerometer positioned on a bottom hole assembly including the drill bit.

10. The method of claim 1 wherein the sensors are in operable communication with at least one data memory to store the time domain force and motion data.

11. The method of claim 1 wherein the processor includes a digital signal processor in communication with a data memory, the digital signal processor to transform data, the time domain force and motion data into spectral representations and store the spectral representation in the data memory.

12. The method of claim 1 wherein the spectral pairings include spectral ensembles, the spectral ensembles each including a force spectral ensemble and a displacement spectral ensemble.

13. A method of characterizing rock strength properties comprising:
accessing, using a processor, time domain force and motion data collected from a sensor associated with a drill bit interacting with a rock formation while drilling a wellbore;
accessing, using the processor, spectral pairings of force amplitude and motion amplitude, the spectral pairings from transforming the time domain force and motion data into frequency domain drill bit force amplitude and motion amplitude data;
identifying, using the processor, an elastic plastic transition of the rock formation, the elastic plastic transition from a distribution of the spectral pairings of force amplitude and motion amplitude data;
identifying, using the processor, a force at a point of the elastic plastic transition; and
identifying, using the processor, a rock strength property from the force at the point of the elastic plastic transition.

14. The method of claim 13 wherein the sensor includes a first strain gauge and a second strain gauge, the first strain gauge providing weight-on-bit force information and the second strain gauge providing torque-on-bit force information, and the identifying, using the force includes a weight-on-bit force and a torque-on-bit force, each associated with the drill bit interacting with the rock formation.

15. The method of claim 14 further comprising:
generating, using the processor, a failure criterion from the weight-on-bit force and the torque-on-bit force; and
wherein, identifying, using the processor, a rock strength property from the force at the point of the elastic plastic transition includes generating, from the failure criterion, at least the rock strength property of uniaxial compressive strength, uniaxial tensile strength, and angle of internal friction.

16. The method of claim 15 wherein:
the failure criterion is a Coulomb criterion; and
wherein identifying the force at the elastic plastic transition comprises identifying a torque-on-bit force representative of the rock strength property of at least one of initial yield strength, angle of cohesion, and uniaxial compressive strength.

17. The method of claim 13 further comprising accessing, using the processor, spectral pairings of a ratio of motion/force amplitude and a motion amplitude; and
identifying a slope of a distribution of the spectral pairing of the ratio of motion/force amplitude and motion amplitude at a point of elastic plastic transition of the distribution, the slope representing an increase in compliance with an increase in crack length of the rock formation, and proportional to a strain energy release rate.

18. The method of claim 13 wherein accessing, by the processor, spectral pairings generated from transformations of the time domain force and motion data further comprises transforming, using a processor to apply a Fourier transform, the time domain force and motion data into the spectral pairings.

19. The method of claim 13 wherein the force and motion time domain data is captured over a rotation of the drill bit where the formation experiences elastic and plastic deformation.

20. A method of characterizing rock strength properties comprising:
accessing, using a processor, time domain force and motion data collected from sensors associated with a drill bit interacting with a rock formation while drilling a wellbore;
accessing, using the processor, spectral pairings of a ratio of motion/force amplitude and a motion amplitude, the spectral pairings from transforming the time domain forces and motions data into frequency domain forces and motions data;
identifying a critical strain energy release rate from a distribution of the spectral pairings, the critical strain energy based on a slope of the distribution at a point of elastic plastic transition and a force at the elastic plastic transition.

21. The method of claim 20 wherein the time domain force and motion data is captured during a rotation of the drill bit where the formation experiences elastic and plastic deformation from the drill bit interacting with the rock formation.

22. The method of claim 20 wherein accessing, using the processor, spectral pairings of the ratio of motion/force amplitude and the motion amplitude, the spectral pairings from transforming the time domain drill bit forces and motions data into frequency domain forces and motions data comprises transforming, using the processor to apply a Fourier transform, the drill bit forces and motions data to generate spectral pairings of the ratio of motion/force amplitude and motion amplitude.

23. The method of claim 20 further comprising generating, using the processor, a fracture toughness from the critical strain energy release rate, the fracture toughness for a location of the wellbore where the time domain force and motion data was collected from sensors associated with a drill bit interacting with a rock formation while drilling the wellbore.

24. The method of claim 20 wherein the force is an initial yield strength from a force displacement distribution generated, by the processor, based on spectral pairings generated from transforming the time domain forces and motions data.

25. A well drilling tool comprising:
a first sensor and a second sensor mounted on a component of a bottom hole assembly, the first sensor generating a first time domain signal representative of a force on a drill bit and the second sensor generating a second time domain signal representative of a motion of the drill bit; and
a processor in communication with a computer readable memory, the first time domain signal and the second time domain signal stored in the computer readable memory, the processor configured to apply a transform to the first time domain signal to generate and store a frequency domain representation of the first time domain signal and to generate and store a frequency domain representation of the second time domain signal;
where the frequency domain representation of the first time domain signal and the frequency domain representation of the second time domain signal may be used to generate a force displacement distribution associated with a rock formation where the forces and motions on the drill bit were recorded.

26. The well drilling tool of claim 25 wherein the force is torque-on-bit and the motion is an angular acceleration, the force displacement distribution being based on spectral pairing of the frequency domain representations of torque-on-bit and a displacement derived from an angular acceleration.

27. An apparatus comprising:
a processing unit in communication with at least one tangible machine readable media including computer executable instructions to perform the operations of:
accessing, by a processor, time domain force and motion data collected from sensors associated with a drill bit interacting with a rock formation while drilling a wellbore;
accessing, by the processor, spectral pairings generated from transformations of the time domain force and motion data; and
generating, by the processor, a rock strength property from a distribution of the spectral pairings.

28. An apparatus comprising:
a processing unit in communication with at least one tangible machine readable media including computer executable instructions to perform the operations of:
accessing time domain force and motion data collected from a sensor associated with a drill bit interacting with a rock formation while drilling a wellbore;
accessing spectral pairings of force amplitude and motion amplitude, the spectral pairings from transforming the time domain drill bit forces and motions data in frequency domain drill bit forces and motions data;
identifying an elastic plastic transition of the rock formation, the elastic plastic transition from a distribution of the spectral pairings of force amplitude and motion amplitude;
identifying a force at a point of the elastic plastic transition;
identifying a rock strength property from the force at the point of the elastic plastic transition.

29. An apparatus comprising:
a processing unit in communication with at least one tangible machine readable media including computer executable instructions to perform the operations of:
accessing time domain force and motion data collected from sensors associated with a drill bit interacting with a rock formation while drilling a wellbore;
accessing spectral pairings of a ratio of motion/force amplitude and a motion amplitude, the spectral pairings from transforming the time domain forces and motions data into frequency domain forces and motions data; and
identifying a critical strain energy release rate from a distribution of the spectral pairings, the critical strain energy based on a slope of the distribution at a point of elastic plastic transition and a force at the elastic plastic transition.

30. A method of characterizing rock properties while drilling comprising:
generating, using a processor, a distribution of spectral pairings of a plurality of forces and a plurality of displacements based on acoustical signals obtained from one or more sensors positioned on a component of a bottom hole assembly, the acoustical signals generated from a drill bit interacting with a rock formation while drilling a wellbore, the acoustical signals processed to obtain to obtain the plurality of forces and the plurality of displacements acting on the drill bit interacting with the rock formation while drilling the wellbore; and
processing the spectral pairings to obtain a rock strength property from the distribution of the spectral pairings.

31. The method of claim 30, the method further comprising:
correlating the rock strength property to a location along the wellbore; and
identifying a change in the rock strength property relative to a rock strength property for another location along the well bore.

32. The method of claim 30 wherein the one or more sensors are in operable communication with at least one data memory to store the acoustical signals.

33. The method of claim 30 wherein the acoustical signals are from vibrations generated from the drill bit interacting with the rock formation while drilling the wellbore.

34. The method of claim 30 wherein the acoustical signals include an axial acceleration of the drill bit and a lateral or rotary acceleration of the drill bit.

35. A method of hydraulic fracturing comprising:
receiving a well log spatially identifying a plurality of mechanical discontinuities in a wellbore, the plurality of mechanical discontinuities indicative of a respective plurality of preexisting fractures along the wellbore, the well log generated from a data set representative of a mechanical rock property of a formation along the wellbore and from a bottom hole assembly, the data set generated by:
accessing, by a processor, time domain force and motion data collected from sensors associated with a drill bit interacting with a rock formation while drilling a wellbore;
accessing, by the processor, spectral pairings generated from transformations of the time domain force and motion data; and
generating, by the processor, a rock strength property from a distribution of the spectral pairing; and
completing the wellbore based on the plurality of mechanical discontinuities indicative of the respective plurality of preexisting fractures.

36. The method of claim 20 wherein completing comprises hydraulic fracturing the wellbore in the area of the plurality of mechanical discontinuities.
